(19) United States
(12) Patent Application Publication
(10) Pub. No.: US 2024/0191005 A1
(43) Pub. Date: Jun. 13, 2024

(54) RESIN COMPOSITION, ADHESIVE MEMBER, AND DISPLAY DEVICE INCLUDING THE ADHESIVE MEMBER

(71) Applicant: Samsung Display Co., Ltd., Yongin-si (KR)

(72) Inventors: Katsuhiro YAMAMOTO, Yokohama (JP); Hideo UMEDA, Yokohama (JP); BOO-KAN KI, Yongin-si (KR); DONG-HUN KANG, Yongin-si (KR); HO YUN BYUN, Yongin-si (KR); DONGHYEON LEE, Yongin-si (KR); Sebeen LEE, Yongin-si (KR); JEONGIN LEE, Yongin-si (KR)

(21) Appl. No.: 18/483,476

(22) Filed: Oct. 9, 2023

(30) Foreign Application Priority Data
Dec. 9, 2022 (KR) 10-2022-0171670
Jan. 27, 2023 (KR) 10-2023-0010634

(51) Int. Cl. C08F 20/06; C08F 20/26; C08F 20/34; C09J 133/08; C09J 133/14

(52) U.S. Cl. CPC C08F 20/06; C08F 20/26; C08F 20/34; C09J 133/08; C09J 133/14; C09D 11/30

(57) ABSTRACT

A resin composition of an embodiment may include at least one oligomer, a plurality of monofunctional acrylate monomers, and at least one photoinitiator. The plurality of monofunctional acrylate monomers may include first to third acrylate monomers. The first monofunctional acrylate monomer includes a hydroxy group, and may have a weight of 5 wt % to 20 wt % based on the total weight of the resin composition. The second monofunctional acrylate monomer includes a branched alkyl group having 10 to 20 carbon atoms, and may have a weight of 25 wt % to 40 wt % based on the total weight of the resin composition. The third monofunctional acrylate monomer includes a non-aromatic ring group, and may have a weight of 20 wt % to 30 wt % based on the total weight of the resin composition. Accordingly, the resin composition of an embodiment may exhibit suitable discharge stability, and may exhibit suitable adhesion reliability.

### CROSS-REFERENCE TO RELATED APPLICATIONS

This application claims priority to and the benefit of Korean Patent Application Nos. 10-2022-0171670, filed on Dec. 9, 2022, and 10-2023-0010634, filed on Jan. 27, 2023, the entire content of both applications is hereby incorporated by reference.

### BACKGROUND

### 1. Field

Embodiments of present disclosure herein relate to a resin composition, an adhesive member formed from the resin composition, and a display device including the adhesive member.

### 2. Description of the Related Art

Various display devices utilized for multimedia (e.g., multimedia devices), such as a television, a mobile phone, a tablet computer, a navigation system, and/or a game machine, are being developed. Here, it may be required or desired to have an adhesive resin utilized for forming an adhesive member that can be applied to display devices of one or more suitable shapes while having excellent or suitable coating properties for one or more suitable forms of members of the display devices.

### SUMMARY

Aspects of embodiments are directed toward a resin composition having excellent or suitable discharge stability before curing, and high adhesion after the curing, an adhesive member prepared from the resin composition, and a display device including the adhesive member.

Additional aspects will be set forth in part in the description which follows and, in part, will be apparent from the description, or may be learned by practice of the presented embodiments of the disclosure.

According to one or more embodiments of the present disclosure a resin composition may include at least one oligomer, a plurality of monofunctional acrylate monomers, and at least one photoinitiator, wherein the plurality monofunctional acrylate monomers include a first monofunctional acrylate monomer having a weight of 5 wt % to 20 wt % based on the total weight of the resin composition, and including a hydroxy group, a second monofunctional acrylate monomer having a weight of 25 wt % to 40 wt % based on the total weight of the resin composition, and including a branched alkyl group having 10 to 20 carbon atoms, and a third monofunctional acrylate monomer having a weight of 20 wt % to 30 wt % based on the total weight of the resin composition, and including a non-aromatic ring group.

In an embodiment, when the resin composition is applied in a first pattern utilizing a discharge device, and a second pattern having the same area and the same shape as the first pattern is applied on the first pattern after one hour, the first pattern and the second pattern may match.

In an embodiment, when the resin composition having a first weight becomes the resin composition having a second weight after 1 hour in an open system at a temperature of 30° C., the amount of change in the second weight to the first weight may be less than 0.1%.

In an embodiment, the plurality of monofunctional acrylate monomers may not include a (e.g., may exclude any) monofunctional acrylate monomer including only an unsubstituted alkyl group having 1 to 8 carbon atoms.

In an embodiment, based on the total weight of the resin composition, the weight of the third monofunctional acrylate monomer may be greater than each of the weight of the first monofunctional acrylate monomer and the weight of the second monofunctional acrylate monomer.

In an embodiment, the oligomer may include a first urethane acrylate having a weight average molecular weight of 5,000 to 10,000 and a second urethane acrylate having a weight average molecular weight of greater than 10,000 to 40,000.

In an embodiment, based on the total weight of the resin composition, the sum of the weight of the first urethane acrylate and the weight of second urethane acrylate may be 5 wt % to 15 wt %.

In an embodiment, based on the total weight of the resin composition, the weight of the second urethane acrylate may be greater than the weight of the first urethane acrylate.

In an embodiment, the resin composition may have a viscosity of 5 mPa·s to 30 mPa·s as measured (e.g., measured by the JIS Z8803 method) at a temperature of 25° C.

In an embodiment, after photo-curing, the 180° peel strength of the resin composition for a glass substrate at a temperature of 25° C. may be 1000 gf/25 mm or greater.

In an embodiment, the resin composition may be provided by an inkjet printing method or a dispensing method.

In an embodiment of the present disclosure, an adhesive member includes a polymer derived from a resin composition including at least one oligomer, a plurality of monofunctional acrylate monomers, and at least one photoinitiator, wherein the plurality of monofunctional acrylate monomers include a first monofunctional acrylate monomer having a weight of 5 wt % to 20 wt % based on the total weight of the resin composition, and including a hydroxy group, a second monofunctional acrylate monomer having a weight of 25 wt % to 40 wt % based on the total weight of the resin composition, and including a branched alkyl group having 10 to 20 carbon atoms, and a third monofunctional acrylate monomer having a weight of 20 wt % to 30 wt % based on the total weight of the resin composition, and including a non-aromatic ring group.

In an embodiment, the adhesive member may have a 180° peel strength of 1000 gf/25 mm or greater for a glass substrate at a temperature of 25° C.

In an embodiment, when the resin composition is applied in a first pattern utilizing a discharge device, and a second pattern having the same area and the same shape as the first pattern is applied on the first pattern after one hour, the first pattern and the second pattern may match.

In an embodiment, when the resin composition having a first weight becomes the resin composition having a second weight after 1 hour in an open system at a temperature of 30° C., the amount of change in the second weight to the first weight may be less than 0.1%.

In an embodiment, the plurality of monofunctional acrylate monomers may not include a (e.g., may exclude any) monofunctional acrylate monomer including only an unsubstituted alkyl group having 1 to 8 carbon atoms.

In an embodiment, based on the total weight of the resin composition, the weight of the third monofunctional acrylate monomer may be greater than the weight of the first monofunctional acrylate monomer and the weight of the second monofunctional acrylate monomer.

In an embodiment, the oligomer may include a first urethane acrylate having a weight average molecular weight of 5,000 to 10,000 and a second urethane acrylate having a weight average molecular weight of greater than 10,000 to 40,000.

In an embodiment, the resin composition may have a viscosity of 5 mPa·s to 30 mPa·s when measured at a temperature of 25° C.

In an embodiment of the present disclosure, a display device includes a display panel, a window disposed on the display panel, and an adhesive member including a polymer derived from a resin composition which includes at least one oligomer, a plurality of monofunctional acrylate monomers, and at least one photoinitiator, and between the display panel and the window, wherein the plurality of monofunctional acrylate monomers include a first monofunctional acrylate monomer having a weight of 5 wt % to 20 wt % based on the total weight of the resin composition, and including a hydroxy group, a second monofunctional acrylate monomer having a weight of 25 wt % to 40 wt % based on the total weight of the resin composition, and including a branched alkyl group having 10 to 20 carbon atoms, and a third monofunctional acrylate monomer having a weight of 20 wt % to 30 wt % based on the total weight of the resin composition, and including a non-aromatic ring group.

In an embodiment, the adhesive member may have a 180° peel strength of 1000 gf/25 mm or greater for a glass substrate at a temperature of 25° C.

In an embodiment, the display device may further include an input sensing unit between the display panel and the window, wherein the adhesive member may be between the display panel and the input sensing unit or between the input sensing unit and the window.

In an embodiment, the display device may further include a light control layer between the adhesive member and the window, and an optical adhesive layer between the light control layer and the window, wherein the optical adhesive layer may include a polymer derived from the resin composition.

In an embodiment, the oligomer may include at least one of polypropylene glycol (PPG) or polytetrahydrofuran (PTHF).

In an embodiment, based on the total weight of the resin composition, the weight of the polypropylene glycol may be 1 wt % to 10 wt %.

In an embodiment, based on the total weight of the resin composition, the weight of the polytetrahydrofuran may be 1 wt % to 10 wt %.

In an embodiment, the resin composition may further include 3-glycidoxypropyltrimethoxysilane.

### BRIEF DESCRIPTION OF THE DRAWINGS

The accompanying drawings are included to provide a further understanding of the present disclosure, and are incorporated in and constitute a part of this specification. The drawings illustrate example embodiments of the present disclosure and, together with the description, serve to explain principles of the present disclosure. In the drawings:

FIG. 1 is a perspective view showing a display device of an embodiment of the present disclosure;

FIG. 2 is an exploded perspective view showing a display device of an embodiment of the present disclosure;

FIG. 3 is a cross-sectional view showing a portion corresponding to line I-I′ of FIG. 2;

FIG. 4A is a view schematically showing a method for preparing an adhesive member of an embodiment of the present disclosure;

FIG. 4B is a view schematically showing a method for preparing an adhesive member of an embodiment of the present disclosure;

FIG. 4C is a view schematically showing a method for preparing an adhesive member of an embodiment of the present disclosure;

FIG. 4D is a view schematically showing a method for preparing an adhesive member of an embodiment of the present disclosure;

FIG. 5A is a view schematically showing a method for preparing an adhesive member of an embodiment of the present disclosure;

FIG. 5B is a view schematically showing a method for preparing an adhesive member of an embodiment of the present disclosure;

FIG. 5C is a view schematically showing a method for preparing an adhesive member of an embodiment of the present disclosure;

FIG. 6 is a cross-sectional view showing a display device of an embodiment of the present disclosure;

FIG. 7 is a cross-sectional view showing a display device of an embodiment of the present disclosure;

FIG. 8 is a view showing a vehicle in which a display device of an embodiment of the present disclosure is disposed;

FIG. 9 exemplarily shows the pattern of a re-dischargeability evaluation of a resin composition;

FIG. 10A is an image showing the pattern of a re-dischargeability evaluation in an example;

FIG. 10B is an image showing the pattern of a re-dischargeability evaluation in a comparative example;

FIG. 11 is a graph showing the storage modulus according to temperatures in a comparative example and an example; and

FIG. 12 is a graph showing the 180° peel strength in an example.

### DETAILED DESCRIPTION

The present disclosure may be modified in many alternate forms, and thus specific embodiments will be exemplified in the drawings and described in more detail. It should be understood, however, that it is not intended to limit the present disclosure to the particular forms disclosed, but rather, is intended to cover all modifications, equivalents, and alternatives falling within the spirit and scope of the present disclosure.

In the present disclosure, when an element (or a region, a layer, a portion, etc.) is referred to as being “on,” “connected to,” or “coupled to” another element, it refers to that the element may be directly disposed on/connected to/coupled to the other element, or that a third element may be disposed therebetween.

Like reference numerals refer to like elements. Also, in the drawings, the thickness, the ratio, and the dimensions of elements are exaggerated for an effective description of technical contents. The term “and/or” includes any and all combinations of one or more of which associated elements may define.

It will be understood that, although the terms “first,” “second,” etc. may be utilized herein to describe one or more suitable elements, these elements should not be limited by these terms. These terms are only utilized to distinguish one element from another. For example, a first element may be referred to as a second element, and a second element may also be referred to as a first element in a similar manner without departing the scope of rights of the present disclosure. The terms of a singular form may include plural forms unless the context clearly indicates otherwise.

In some embodiments, terms such as “below,” “lower,” “above,” “upper,” and/or the like are utilized to describe the relationship of the elements shown in the drawings. The terms are utilized as a relative concept and are described with reference to the direction indicated in the drawings.

It should be understood that the term “comprise,” or “have” is intended to specify the presence of stated features, integers, steps, operations, elements, components, or combinations thereof in the disclosure, but do not preclude the presence or addition of one or more other features, integers, steps, operations, elements, components, or combinations thereof.

As utilized herein, the term “and/or”, “or”, etc., may include any and all combinations of one or more of the associated listed items. Throughout the disclosure, the expression “at least one of a, b or c”, “at least one of a, b, and/or c”, “at least one selected from among a, b, and c”, “at least one among a, b, or c”, etc., (three or more item case), indicates only a, only b, only c, both (e.g., simultaneously) a and b, both (e.g., simultaneously) a and c, both (e.g., simultaneously) b and c, all of a, b, and c, or variations thereof.

In the present specification, “A and/or B”, “A or B”, etc., may represent A or B, or A and B. The expression “at least one of A and B”, “one of A and B”, “one selected from A and B”, etc., (two item case) indicates only A, only B, both (e.g., simultaneously) A and B, or variations thereof.

As used herein, the term “substantially,” “about,” and similar terms are used as terms of approximation and not as terms of degree, and are intended to account for the inherent deviations in measured or calculated values that would be recognized by those of ordinary skill in the art. “About” or “substantially”, as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” or “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The display device and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the [device] may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

Unless otherwise defined, all terms (including technical and scientific terms) utilized herein have the same meaning as commonly understood by one of ordinary skill in the art to which the present disclosure pertains. It is also to be understood that terms such as terms defined in commonly utilized dictionaries should be interpreted as having meanings consistent with the meanings in the context of the related art, and should not be interpreted in too ideal a sense or an overly formal sense unless explicitly defined herein.

In the present specification, “unsubstituted” may refer to that a hydrogen atom is not substituted with a substituent other than the hydrogen atom. In the present specification, “substituted” may refer to being substituted with one or more substituents selected from the group consisting of a deuterium atom, a halogen atom, a cyano group, a nitro group, an amine group, a silyl group, an oxy group, a thio group, a sulfinyl group, a sulfonyl group, a carbonyl group, a boron group, a phosphine oxide group, a phosphine sulfide group, an alkyl group, an alkenyl group, an alkynyl group, a hydrocarbon ring group, an aryl group, and a hetero ring group. In some embodiments, each of the substituents illustrated above may be substituted or unsubstituted. For example, a biphenyl group may be interpreted as an aryl group, and may be interpreted as a phenyl group substituted with a phenyl group.

In the present specification, the alkyl group may be linear or branched. For example, the number of carbon atoms of the alkyl group is 1 to 60, 1 to 50, 1 to 30, 1 to 20, 1 to 10, or 1 to 6. Examples of the alkyl group may include a methyl group, an ethyl group, an n-propyl group, an isopropyl group, an n-butyl group, an s-butyl group, a t-butyl group, an i-butyl group, a 2-ethylbutyl group, a 3,3-dimethylbutyl group, an n-pentyl group, an i-pentyl group, a neopentyl group, a t-pentyl group, a 1-methylpentyl group, a 3-methylpentyl group, a 2-ethylpentyl group, a 4-methyl-2-pentyl group, an n-hexyl group, a 1-methylhexyl group, a 2-ethylhexyl group, a 2-butylhexyl group, an n-heptyl group, a 1-methylheptyl group, a 2,2-dimethylheptyl group, a 2-ethylheptyl group, a 2-butylheptyl group, an n-octyl group, a t-octyl group, a 2-ethyloctyl group, a 2-butyloctyl group, a 2-hexyloctyl group, a 3,7-dimethyloctyl group, an n-nonyl group, an n-decyl group, an adamantly group, a 2-ethyldecyl group, a 2-butyldecyl group, a 2-hexyldecyl group, a 2-octyldecyl group, an n-undecyl group, an n-dodecyl group, a 2-ethyldodecyl group, a 2-butyldodecyl group, a 2-hexyldodecyl group, a 2-octyldodecyl group, an n-tridecyl group, an n-tetradecyl group, an n-pentadecyl group, an n-hexadecyl group, a 2-ethylhexadecyl group, a 2-butylhexadecyl group, a 2-hexylhexadecyl group, a 2-octylhexadecyl group, an n-heptadecyl group, an n-octadecyl group, an n-nonadecyl group, an n-eicosyl group, a 2-ethyleicosyl group, a 2-butyleicosyl group, a 2-hexyleicosyl group, a 2-octyleicosyl group, an n-heneicosyl group, an n-docosyl group, an n-tricosyl group, an n-tetracosyl group, an n-pentacosyl group, an n-hexacosyl group, an n-heptacosyl group, an n-octacosyl group, an n-nonacosyl group, and an n-triacontyl group, and/or the like, but are not limited thereto.

In the present specification, a non-aromatic ring group refers to any functional group or substituent derived from a ring group that is not aromatic. The non-aromatic ring group may include an aliphatic hydrocarbon ring group and an aliphatic heterocyclic group. The non-aromatic ring group may be monocyclic or polycyclic. For example, the number of ring-forming carbon atoms of the non-aromatic ring group may be 2 to 60, 2 to 30, 2 to 20, or 2 to 10. The non-aromatic ring group may also be referred to as alicyclic.

In the present specification, the aliphatic hydrocarbon ring group refers to any functional group or substituent derived from an aliphatic hydrocarbon ring. The aliphatic hydrocarbon ring group may be a saturated hydrocarbon ring group. For example, the number of ring-forming carbon atoms of a hydrocarbon ring group may be 5 to 60, 5 to 30, 5 to 20, or 5 to 10.

In the present specification, the aliphatic heterocyclic group refers to any functional group or substituent derived from a ring including one or more hetero atoms. For example, the hetero atom may include B, O, N, P, Si, and S. For example, the number of ring-forming carbon atoms of the aliphatic heterocyclic group may be 2 to 60, 2 to 30, 2 to 20, or 2 to 10.

Hereinafter, with reference to the drawings, an adhesive member of an embodiment and a display device of an embodiment will be described.

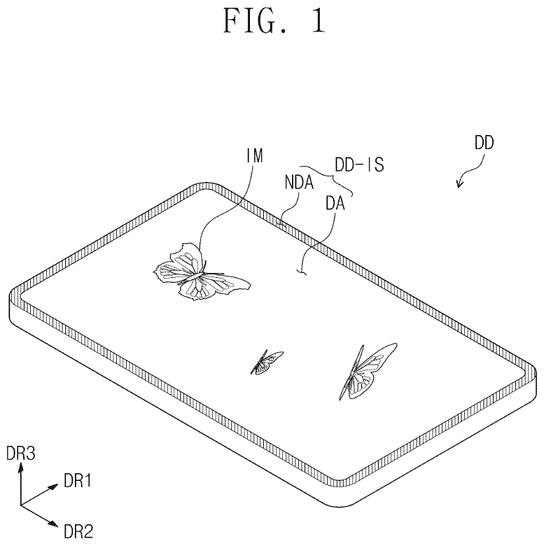

FIG. 1 is a perspective view showing a display device of an embodiment of the present disclosure. A display device DD of an embodiment may be a device activated according to an electrical signal. For example, the display device DD may be a or with a television, an external billboard, a portable electronic apparatus, a tablet computer, a car navigation system unit, a game console, a monitor, a personal computer, a laptop computer, or a wearable device, but is not limited thereto.

The display device DD may display an image IM through a display surface DD-IS. The display surface DD-IS may be parallel to a plane defined by a first direction axis DR1 and a second direction axis DR2. The display surface DD-IS may include a display region DA and a non-display region NDA.

The non-display region NDA may be defined along the edge of the display surface DD-IS. The non-display region NDA may surround the display region DA. However, the embodiment of the present disclosure is not limited thereto, and the non-display region NDA may not be provided, or the non-display region NDA may be disposed on only one side of the display region DA.

FIG. 1 illustrates the display device DD provided with a planar display surface DD-IS, but the embodiment of the present disclosure is not limited thereto. The display device DD may include a curved display surface or a three-dimensional display surface. The three-dimensional display surface may include a plurality of display regions indicating different directions.

In FIG. 1 and the following drawings, the first direction axis DR1 to a third direction axis DR3 are illustrated, and directions indicated by the first to third direction axes DR1, DR2, and DR3 described in the present disclosure are relative concepts, and may be converted to different directions. In some embodiments, the directions indicated by the first to third direction axes DR1, DR2, and DR3 may be described as first to third directions, and may be denoted by the same reference numerals. In the present disclosure, the first direction axis DR1 and the second direction axis DR2 are perpendicular to each other, and the third direction axis DR3 may be a normal direction with respect to a plane defined by the first direction axis DR1 and the second direction axis DR2.

A thickness direction of the display device DD may be a direction parallel to the third direction axis DR3, which is the normal direction with respect to the plane defined by the first direction axis DR1 and the second direction axis DR2. In the present specification, a front surface (e.g., an upper surface, an upper portion surface, an upper side, etc.) and a back surface (e.g., a lower surface, a lower portion surface, a lower side, etc.) of members constituting the display device DD may be defined with respect to the third direction axis DR3. In some embodiments, in the present specification, the front surface (or the upper surface, the upper portion surface, the upper side) refers to a surface (or a direction) adjacent to the display surface DD-IS on which the image IM is displayed, and the back surface (or the lower surface, the lower portion surface, the lower side) refers to a surface (or a direction) spaced apart from the display surface DD-IS on which the image IM is displayed.

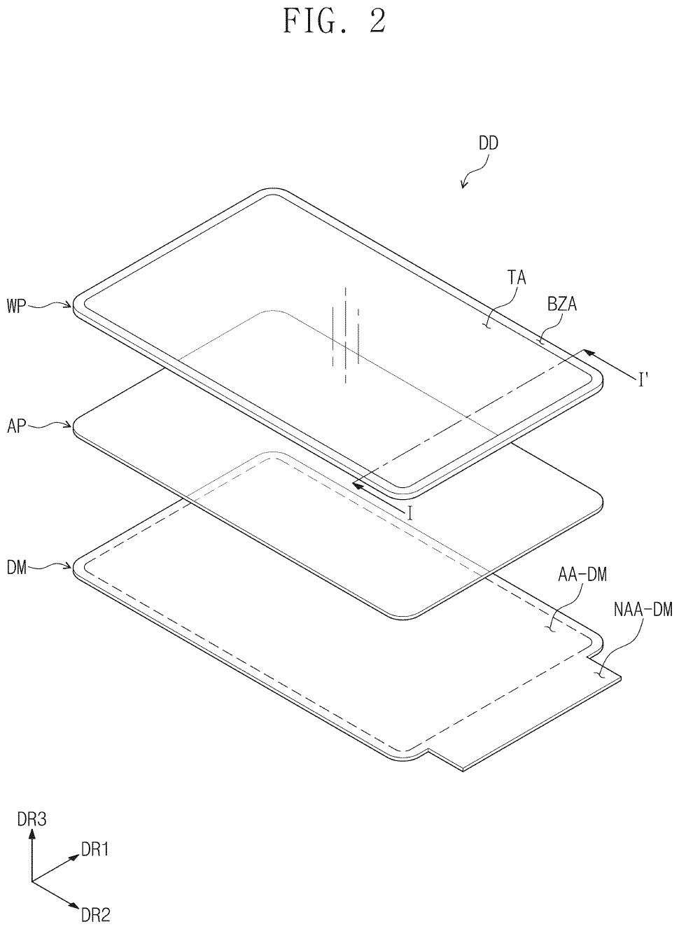

FIG. 2 is an exploded perspective view showing a display device of an embodiment of the present disclosure. Referring to FIG. 2, the display device DD may include a display module DM, a window WP disposed on the display module DM, and an adhesive member AP disposed between the display module DM and the window WP.

The display module DM may be activated according to an electrical signal. The display module DM may be activated to display the image IM (see FIG. 1) in the display region DA (see FIG. 1) of the display device DD. In the display module DM, an active region AA-DM and a peripheral region NAA-DM may be defined. The active region AA-DM may be a region activated according to an electrical signal. The peripheral region NAA-DM may be a region positioned adjacent to at least one side of the active region AA-DM. In the peripheral region NAA-DM, a circuit, a line, and/or the like for driving the active region AA-DM may be disposed.

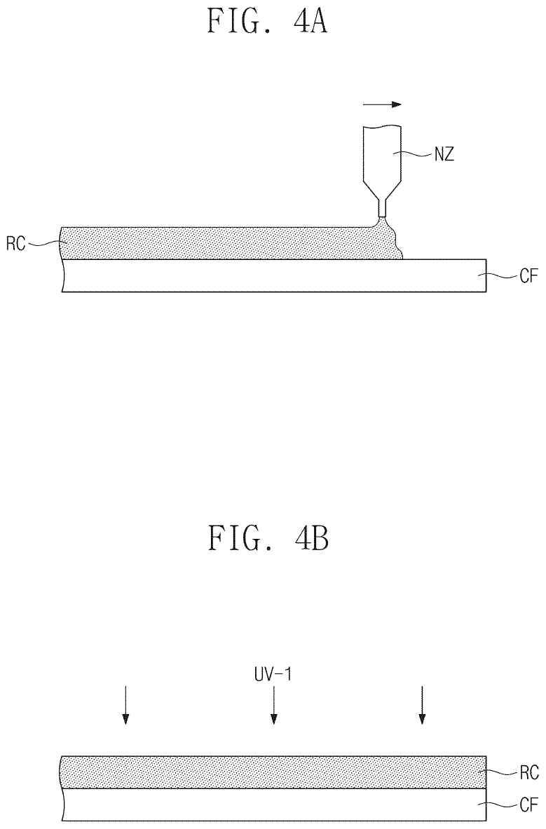

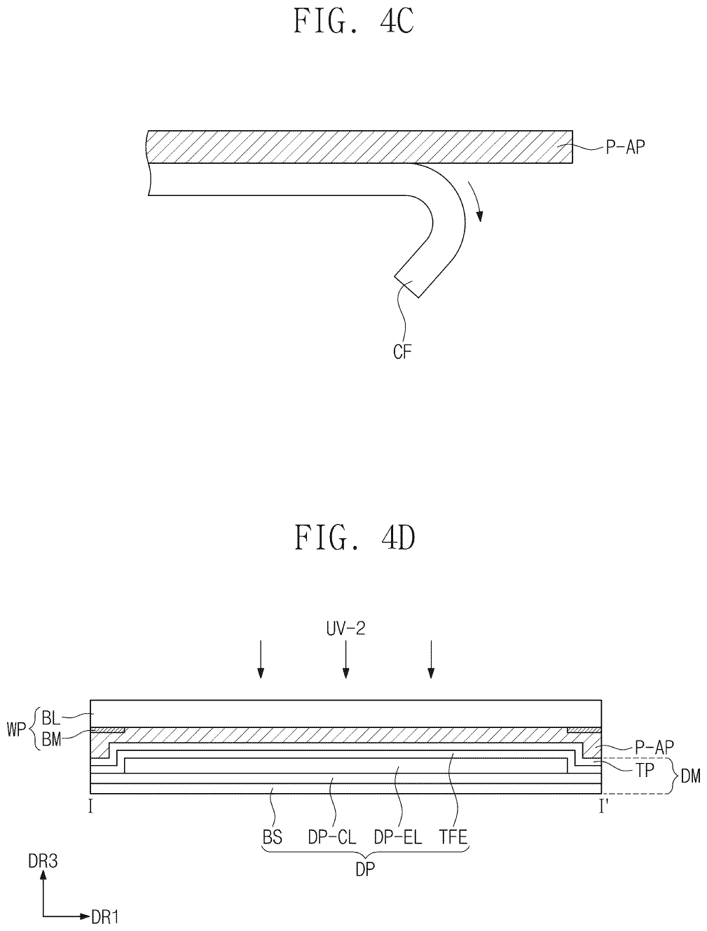

The display module DM and the window WP may be coupled by the adhesive member AP. In an embodiment, the adhesive member AP may include a polymer derived from a resin composition RC (see FIGS. 4A and 5A). The adhesive member AP may be formed from the resin composition RC (see FIGS. 4A and 5A). The adhesive member AP formed from the resin composition RC (see FIGS. 4A and 5A) may exhibit excellent or suitable adhesion reliability.

The window WP may include a transmission region TA and a bezel region BZA. The transmission region TA may overlap at least a portion of the active region AA-DM of the display module DM. The transmission region TA may be an optically transparent region. The image IM (see FIG. 1) may be provided to a user through the transmission region TA.

The bezel region BZA may be a region having relatively low light transmittance compared to the transmission region TA. The bezel region BZA may define the shape of the transmission region TA. The bezel region BZA may be adjacent to the transmission region TA, and may be around (e.g., may surround) the transmission region TA.

The bezel region BZA may have a set or predetermined color. The bezel region BZA may cover the peripheral region NAA-DM of the display module DM to block or reduce the peripheral region NAA-DM from being visually recognized from the outside. However, the embodiment of the present disclosure is not limited to what is illustrated, and the bezel region BZA may be disposed adjacent to only one side of the transmission region TA, or at least a portion thereof may not be provided.

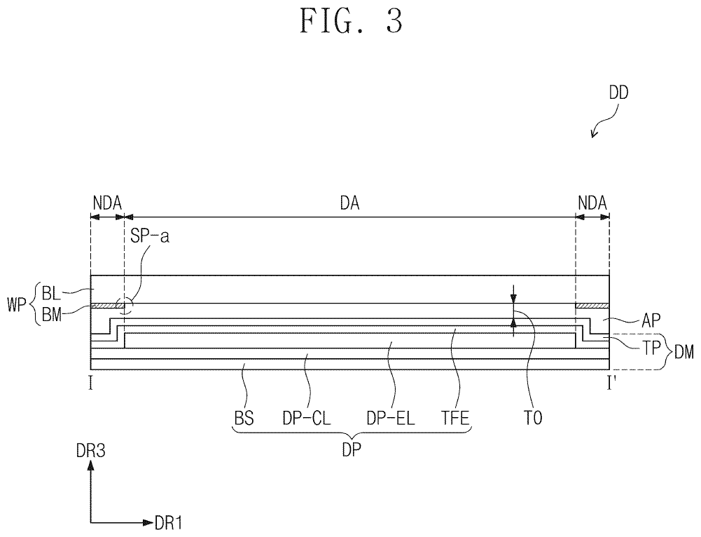

FIG. 3 is a cross-sectional view showing a portion corresponding to line I-I′ of FIG. 2. FIG. 3 may be a cross-sectional view showing a display device of an embodiment of the present disclosure.

Referring FIG. 3, the display module DM may include a display panel DP and an input sensing unit TP disposed on the display panel DP. The display panel DP may include a base substrate BS, a circuit layer DP-CL disposed on the base substrate BS, a display element layer DP-EL disposed on the circuit layer DP-CL, and an encapsulation layer TFE covering the display element layer DP-EL. The adhesive member AP may be disposed between the display panel DP and the window WP. For example, the adhesive member AP may be disposed between the input sensing unit TP and the window WP.

In some embodiments, the configuration of the display panel DP illustrated in FIG. 3 is example, and the configuration of the display panel DP is not limited thereto. For example, the display panel DP may include a liquid crystal element, in which case the encapsulation layer TFE may not be provided.

The base substrate BS may provide a base surface on which the circuit layer DP-CL is disposed. The base substrate BS may be a flexible substrate capable of bending, folding, rolling, and/or the like. The base substrate BS may be a glass substrate, a metal substrate, a polymer substrate, and/or the like. However, the embodiment of the present disclosure is not limited thereto, and the base substrate BS may include an inorganic layer, an organic layer, or a composite material layer.

The circuit layer DP-CL may include an insulation layer, a semiconductor pattern, a conductive pattern, a signal, and/or the like. For example, the circuit layer DP-CL may include a switching transistor and a driving transistor for driving light emitting element of the display element layer DP-EL.

The display element layer DP-EL may include the light emitting element for emitting light. For example, the light emitting element may include an organic light emitting material, an inorganic light emitting material, an organic-inorganic light emitting material, a quantum dot, a quantum rod, a micro-LED, or a nano-LED.

The encapsulant layer TFE may be disposed on an upper side of the display element layer DP-EL. The encapsulation layer TFE may protect the display element layer DP-EL from foreign substances such as moisture, oxygen, and/or dust particles. The encapsulation layer TFE may include at least one inorganic layer. In some embodiments, the encapsulation layer TFE may include at least one organic layer and at least one inorganic layer. For example, the encapsulation layer TFE may include an inorganic layer, an organic layer, and an inorganic layer which are sequentially laminated.

The input sensing unit TP may be disposed on the display panel DP. For example, the input sensing unit TP may be directly disposed on the encapsulation layer TFE of the display panel DP. The input sensing unit TP may sense an external input and change the external input to a set or predetermined input signal, and provide the input signal to the display panel DP. For example, in the display device DD of an embodiment, the input sensing unit TP may be a touch sensing unit configured to sense a touch. The input sensing unit TP may recognize a direct touch of a user, an indirect touch of a user, a direct touch of an object, an indirect touch of an object, and/or the like.

The input sensing unit TP may sense at least one selected from among the position of a touch applied externally and the intensity (e.g., pressure) of the touch. The input sensing unit TP may have one or more suitable configurations, or may be composed of one or more suitable materials, and is not limited to any one embodiment. The input sensing unit TP may include a plurality of sensing electrodes configured to sense an external input. The sensing electrodes may sense the external input in a capacitive manner. The display panel DP receives an input signal from the input sensing unit TP, and may generate an image corresponding to the input signal.

The window WP may include a base layer BL and a print layer BM. In some embodiments, the window WP may further include at least one functional layer provided on the base layer BL. For example, the functional layer may be a hard coating layer, an anti-fingerprint layer, and/or the like, but the embodiment of the present disclosure is not limited thereto.

The base layer BL may be a glass substrate. In some embodiments, the base layer BL may be a plastic substrate. For example, the base layer BL may be made of polyimide, polyacrylate, polymethylmethacrylate, polycarbonate, polyethylenenaphthalate, polyvinylidene chloride, polyvinylidene difluorid, polystyrene, an ethylene vinylalcohol copolymer, or a combination thereof.

The print layer BM may be disposed on one surface of the base layer BL. The print layer BM may be provided on a lower surface of the base layer BL adjacent to the display module DM. The print layer BM may be disposed in an edge region of the base layer BL. The print layer BM may be an ink print layer. In some embodiments, the print layer BM may be a layer formed by including a pigment or a dye. In the window WP, the bezel region BZA may be a portion in which the print layer BM is provided.

The adhesive member AP may be disposed in a lower portion of the window WP. In the window WP, there may be a step SP-a present between the base layer BL on which the print layer BM is not provided and the print layer BM. The adhesive member AP formed from the resin composition RC (see FIGS. 4A and 5A) according to one embodiment has good or suitable flexibility and high adhesion, and thus may be attached to the window WP without lifting in the step SP-a portion.

A thickness TO of the adhesive member AP may be 50 μm to 200 μm. For example, the adhesive member AP may have the thickness TO of 50 μm to 100 μm. However, this is an example, and the thickness TO of the adhesive member AP is not limited thereto.

In an embodiment, the adhesive member AP may have a 180° peel strength (e.g., the peel force divided by the specimen width) of 1000 gf/25 mm or greater for a glass substrate at a temperature of 25° C. An adhesive member having a 180° peel strength of less than 1000 gf/25 mm for a glass substrate at a temperature of 25° C. is peeled off from a component such as the display module DM or the window WP. On the other hand, the adhesive member AP of an embodiment having a 180° peel strength of 1000 gf/25 mm or greater for a glass substrate at a temperature of 25° C. may exhibit excellent or suitable adhesion. The display device DD including the adhesive member AP of an embodiment may exhibit excellent or suitable reliability.

In some embodiments, the adhesive member AP may have a 180° peel strength of 3000 gf/25 mm or greater for a polymer substrate at a temperature of 25° C. The adhesive member AP having a 180° peel strength of 3000 gf/25 mm or greater for a polymer substrate at a temperature of 25° C. may exhibit excellent or suitable adhesion reliability.

The adhesive member AP formed from the resin composition RC (see FIG. 5) according to an embodiment may exhibit a relatively high storage modulus G′ at high temperatures. For example, the adhesive member AP formed from the resin composition RC (see FIG. 5) according to an embodiment may have a storage modulus of 0.02 MPa or greater at a temperature of 60° C. to 80° C. In some embodiments, the adhesive member AP formed from the resin composition RC (see FIGS. 4A and 5A) according to an embodiment may have a storage modulus of 0.03 MPa to 0.04 MPa at a temperature of 60° C. to 80° C. The adhesive member AP which exhibits a relatively high storage modulus at high temperatures may exhibit excellent or suitable durability at high temperatures. Accordingly, the display device DD of an embodiment including the adhesive member AP may exhibit excellent or suitable reliability.

FIGS. 4A to 4D schematically show a method for manufacturing the adhesive member AP from the resin composition RC of one embodiment. For example, the method for manufacturing the adhesive member AP may include providing the resin composition RC on a substrate CF, providing a first light UV-1 to the resin composition RC to form a preliminary adhesive member P-AP, and providing a second light UV-2 to the preliminary adhesive member P-AP to form the adhesive member AP.

The resin composition RC may include a monofunctional acrylate monomer having a molecular weight (e.g., a weight average molecular weight (Mw (weight average molar mass, Mw))) of 100 to 500. However, this is example, and the molecular weight of the monofunctional acrylate monomer included in the resin composition RC is not limited thereto.

In the resin composition RC of an embodiment, the monofunctional acrylate monomer may include at least first to third monofunctional acrylate monomers. The first monofunctional acrylate monomer may be a monofunctional acrylate monomer including a hydroxy group. For example, the first monofunctional acrylate monomer may be 4-hydroxybutyl acrylate (4-HBA). The second monofunctional acrylate monomer may be a monofunctional acrylate monomer including a branched alkyl group having 10 to 20 carbon atoms. For example, the second monofunctional acrylate monomer may be Isodecyl acrylate (IDAA). The third monofunctional acrylate monomer may be a monofunctional acrylate monomer including a non-aromatic ring group. For example, the third monofunctional acrylate monomer may be isobornyl acrylate (IBXA). However, the embodiment of the present disclosure is not limited thereto, and within a range that does not impair the discharge stability and volatility of the resin composition RC, the monofunctional acrylate monomer may further include a monomer such as tetrahydrofurfuryl acrylate.

Based on the total weight of the resin composition RC, the weight of the third monofunctional acrylate monomer may be greater than the weight of the first monofunctional acrylate monomer and the weight of the monofunctional acrylate monomer. Based on the total weight of the resin composition RC, the weight of the first monofunctional acrylate monomer may be 5 wt % to 15 wt %. Based on the total weight of the resin composition RC, the weight of the second monofunctional acrylate monomer may be 25 wt % to 40 wt %. Based on the total weight of the resin composition RC, the weight of the third monofunctional acrylate monomer may be 20 wt % to 30 wt %. The resin composition RC including the first to third monofunctional acrylate monomers satisfying the above weight ranges may exhibit excellent or suitable discharge stability, and may exhibit excellent or suitable adhesion reliability after curing.

On the other hand, a resin composition not including at least one monofunctional acrylate monomer among the first to third monofunctional acrylate monomers exhibit low adhesion after curing. A resin composition not including the first monofunctional acrylate monomer exhibits low adhesion after curing. In some embodiments, a resin composition not including the second monofunctional acrylate monomer exhibits high viscosity, and thus is not suitable to be provided from a discharge device such as a nozzle NZ. A resin compositions exhibiting high viscosity is not suitable to be provided by an inkjet printing method or a dispensing method. A resin composition not including the third monofunctional acrylate monomer exhibits high volatility, and thus has degraded discharge stability.

In the resin composition RC of an embodiment, the monofunctional acrylate monomer may not include an (e.g., may exclude any) acrylate monomer including only an unsubstituted alkyl group having 1 to 8 carbon atoms. The resin composition RC may not include (e.g., may exclude) 2-ethylhexyl acrylate (2-EHA). The 2-ethylhexyl acrylate 2-EHA is an acrylate monomer including only an unsubstituted alkyl group having 1 to 8 carbon atoms.

The monofunctional acrylate monomer may include an acrylate monomer including an unsubstituted alkyl group having 1 to 8 carbon atoms and a substituent other than the unsubstituted alkyl group having 1 to 8 carbon atoms. For example, the monofunctional acrylate monomer may include an acrylate monomer including a hydroxy group and an unsubstituted alkyl group having 1 to 8 carbon atoms.

A resin composition including a monofunctional acrylate monomer which includes only an unsubstituted alkyl group having 1 to 8 carbon atoms is not easily re-discharged after a rest period. The resin composition including the monofunctional acrylate monomer which includes only the unsubstituted alkyl group having 1 to 8 carbon atoms has high volatility. When the resin composition having high volatility is paused (or stopped) from being discharged for a set or predetermined amount of time and then resumed for the discharge, components constituting the resin composition and/or physical properties are changed, so that the discharge stability and reliability are degraded. In some embodiments, when the resin composition including the monofunctional acrylate monomer which includes only the unsubstituted alkyl group having 1 to 8 carbon atoms is paused (or stopped) from being discharged for a set or predetermined amount of time and then resumed for the discharge, recharge and preliminary discharge are required to implement a discharge speed and a discharge amount which may each independently be the same as those before the discharge is paused (or stopped). In the case in which the preliminary discharge is not performed, the discharge speed and the discharge amount are different from those before the discharge is paused (or stopped). In some embodiments, when the resin composition including the monofunctional acrylate monomer which includes only the unsubstituted alkyl group having 1 to 8 carbon atoms is paused (or stopped) from being discharged for a set or predetermined amount of time and then resumed for the discharge, a discharge speed and a discharge amount which may each independently be the same as those before the discharge is paused (or stopped) may not be implemented.

On the other hand, in an embodiment, the resin composition RC (not including the (e.g., any) monofunctional acrylate monomer) which includes only the unsubstituted alkyl group having 1 to 8 carbon atoms may exhibit excellent or suitable discharge stability. The resin composition RC not including the monofunctional acrylate monomer which includes only the unsubstituted alkyl group having 1 to 8 carbon atoms may exhibit low volatility. When the resin composition not including the monofunctional acrylate monomer which includes only the unsubstituted alkyl group having 1 to 8 carbon atoms is paused (or stopped) from being discharged for a set or predetermined amount of time and then resumed for the discharge, a discharge speed and a discharge amount which may each independently be the same as those before the discharge is paused (or stopped) may be implemented without recharge and preliminary discharge.

In an embodiment, the resin composition RC may include at least one oligomer, at least one monofunctional acrylate monomer, and at least one photoinitiator.

The oligomer may include a first urethane acrylate and a second urethane acrylate. The first urethane acrylate and the second urethane acrylate may have different weight average molecular weights. The weight average molecular weight of the first urethane acrylate may be smaller than the weight average molecular weight of the second urethane acrylate. The weight average molecular weight (weight average molar mass, Mw) of the first urethane acrylate may be 5,000 to 10,000. The weight average molecular weight (weight average molar mass, Mw) of the second urethane acrylate may be greater than 10,000 to 40,000.

Based on the total weight of the resin composition RC, the weight of the second urethane acrylate may be greater than the weight of the first urethane acrylate. Based on the total weight of the resin composition RC, the sum of the weight of the first urethane acrylate and the weight of the second urethane acrylate may be 5 wt % to 15 wt %. The resin composition RC, in which the sum of the weight of the first urethane acrylate and the weight of the second urethane acrylate is 5 wt % to 15 wt % based on the total weight of the resin composition RC, may have a 180° peel strength of 1000 gf/25 mm or greater for a glass substrate at a temperature of 25° C. after curing. The resin composition RC, in which the sum of the weight of the first urethane acrylate and the weight of the second urethane acrylate is 5 wt % to 15 wt % based on the total weight of the resin composition RC, may prepare the adhesive member AP having excellent or suitable adhesion reliability.

On the other hand, a resin composition, in which the sum of the weight of the first urethane acrylate and the weight of the second urethane acrylate is less than 5 wt % based on the total weight of the resin composition, has low adhesion after curing, and thus is peeled off from an adherend. The resin composition, in which the sum of the weight of the first urethane acrylate and the weight of the second urethane acrylate is less than 5 wt % based on the total weight of the resin composition, has a 180° peel strength of less than 1000 gf/25 mm for a glass substrate at a temperature of 25° C. after curing. On the other hand, a resin composition, in which the sum of the weight of the first urethane acrylate and the weight of the second urethane acrylate is greater than 15 wt % based on the total weight of the resin composition, exhibits high viscosity, and thus is not suitable to be provided from a discharge device such as the nozzle NZ. That is, a resin compositions exhibiting relatively high viscosity is not suitable to be provided by an inkjet printing method or a dispensing method.

For example, the resin composition RC may include, as the first urethane acrylate, at least one of UV-3300B (urethane acrylate, a product of Mitsubishi Chemical Inc.) or UF-C052 (urethane acrylate, a product of Kyoeisha Chemical Co., Ltd). The resin composition RC may include, as the second urethane acrylate, at least one of UV-3700B (urethane acrylate, a product of Mitsubishi Chemical Inc.) or UF-C051 (urethane acrylate, a product of Kyoeisha Chemical Co., Ltd). However, this is an example, and the first and second urethane acrylates are not limited thereto.

The resin composition RC may include at least one oligomer, at least two monomers, and at least one photoinitiator. The monomer may include isodecyl acrylate and 1,9-nonanediol diacrylate. The monomer does not include 2-ethylhexyl acrylate (2-EHA).

The resin composition RC including isodecyl acrylate may have a viscosity of less than 10 mPa·s at a temperature of 25° C. In some embodiments, the resin composition RC including isodecyl acrylate may have a first volatility of 1% or less. In an embodiment, the resin composition RC not including 2-ethylhexyl acrylate, but including isodecyl acrylate has relatively low viscosity and relatively low volatility, and thus may be applied in a substantially uniform amount and to a substantially uniform thickness through an inkjet printing method or a dispensing method.

On the other hand, a resin composition including 2-ethylhexyl acrylate has a viscosity of 10 mPa·s or greater at a temperature of 25° C., and has a first volatility of greater than 1%, and thus exhibits relatively high viscosity and relatively high volatility. Thus, the resin composition including 2-ethylhexyl acrylate is not suitable to be provided by an inkjet printing method or a dispensing method.

When heat is provided to the resin composition RC at a temperature of 30° C. for 30 minutes, the amount of change in weight before and after the heat is provided may be less than 1%. The amount of change in weight is represented by a ratio of a value obtained by dividing the difference between an initial weight before heat is provided and a final weight after the heat is provided by the initial weight. In this specification, the term ‘first volatility’ refers to the amount of change in weight when heat is provided at a temperature of 30° C. for 30 minutes.

The resin composition RC having the first volatility of 1% or less may exhibit properties in which the discharge amount and the discharge speed are substantially uniform before and after a rest period. For example, in the step (act or task) of providing the resin composition RC, there may be a rest period during which an inspection of the nozzle NZ for providing the resin composition RC, and/or the like is required. When the resin composition RC is re-discharged after the rest period, the resin composition RC of an embodiment having the first volatility of 1% or less may be provided in a discharge amount and at a discharge speed which are similar to a discharge amount and a discharge speed before the rest period. In some embodiments, after the re-discharge is started, it may take a relatively short time for the resin composition RC of an embodiment having the first volatility of 1% or less to be provided in the discharge amount and at the discharge speed before the rest period. Accordingly, a method for manufacturing a display device, the method including the providing of the resin composition RC of an embodiment may exhibit excellent or suitable manufacturing efficiency.

On the other hand, a resin composition having the first volatility of greater than 1% is provided in a different discharge amount and/or at a different discharge speed from a discharge amount and a discharge speed before a rest period. In some embodiments, after the re-discharge is started, it may take relatively a long time for the resin composition having the first volatility of greater than 1% to be provided in the discharge amount and at the discharge speed before the rest period. At this time, the amount of time required of the resin composition having the first volatility greater than 1% may be 4 times to 6 times the amount of time required of the resin composition RC having the first volatility of less than 1%.

The resin composition RC include isodecyl acrylate, and based on the total weight of the resin composition RC, the weight of isodecyl acrylate may be 30 wt % or greater. For example, based on the total weight of the resin composition RC, the weight of isodecyl acrylate may be about 36.3 wt %. The resin composition RC including 30 wt % or greater of isodecyl acrylate based on the total weight of the resin composition RC may have a viscosity of less than 10 mPa·s as measured with a viscometer TVE-25L (a product of TOKI SANGYO) at a temperature of 25° C., and have a first volatility of 1% or less. The viscosity will be described in more detail later.

The resin composition RC may include 1,9-nonanediol diacrylate. The 1,9-nonandiol diacrylate may increase entanglement properties of a material during a polymerization reaction of the resin composition RC. Accordingly, the resin composition RC including the 1,9-nonandiol diacrylate may be cured within a relatively short amount of time. In some embodiments, the adhesive member AP formed from the resin composition RC including 1,9-nonandiol diacrylate may exhibit a relatively high storage modulus at high temperatures. A method for manufacturing a display device, the method which includes the providing of the resin composition RC including 1,9-nonandiol diacrylate may exhibit excellent or suitable manufacturing efficiency and excellent or suitable manufacturing reliability.

Based on the total weight of the resin composition RC, the weight of 1,9-nonandiol diacrylate may be 0.1 wt % to 2.0 wt %. For example, based on the total weight of the resin composition RC, the weight of 1,9-nonandiol diacrylate may be about 0.5 wt %.

It takes a relatively long time for a resin composition including less than 0.1 wt % of 1,9-nonandiol diacrylate based on the total weight of the resin composition to be cured. The curing speed of a resin composition including greater than 2.0 wt % of 1,9-nonandiol diacrylate based on the total weight of the resin composition is extremely fast. A resin composition with an excessively fast curing speed is not suitable for manufacturing an adhesive member according to the shape of a desired or suitable member. A display device may be composed of members of one or more suitable shapes, and the resin composition with an excessively fast curing speed does not form an adhesive member suitable for the members of one or more suitable shapes.

On the other hand, in an embodiment, the resin composition RC including 0.1 wt % to 2.0 wt % of 1,9-nonandiol diacrylate based on the total weight of the resin composition RC may form an adhesive member AP suitable for the shape of a desired or suitable member in a relatively short amount of time. In some embodiments, the resin composition RC including 0.1 wt % to 2.0 wt % of 1,9-nonandiol diacrylate based on the total weight of the resin composition RC may manufacture the adhesive member AP which exhibits excellent or suitable durability at high temperatures.

The resin composition RC may include at least one of 4-hydroxybutyl acrylate (4-HBA), tetrahydrofurfuryl acrylate (THF-A), or isobornyl acrylate (IBXA). Based on the total weight of the resin composition RC, the weight of 4-hydroxybutyl acrylate may be 5 wt % to 15 wt %. Based on the total weight of the resin composition RC, the weight of tetrahydrofurfuryl acrylate may be 15 wt % to 25 wt %. Based on the total weight of the resin composition RC, the weight of isobornyl acrylate may be 20 wt % to 30 wt %. For example, based on the total weight of the resin composition RC, the weight of 4-hydroxybutyl acrylate may be about 10.4 wt %. Based on the total weight about resin composition RC, the weight of tetrahydrofurfuryl acrylate may be about 20.8 wt %. Based on the total weight about resin composition RC, the weight of isobornyl acrylate may be about 25.8 wt %.

The oligomer may include at least one of polypropylene glycol (PPG) or polytetrahydrofuran (PTHF). Based on the total weight of the resin composition RC, the weight of polypropylene glycol may be 1 wt % to 10 wt %. For example, based on the total weight of the resin composition RC, the weight of polypropylene glycol may be about 2.1 wt %. The adhesive member AP formed from the resin composition RC including 1 wt % to 10 wt % of polypropylene glycol based on the total weight of the resin composition RC may exhibit excellent or suitable toughness properties.

Based on the total weight of the resin composition RC, the weight of polytetrahydrofuran may be 1 wt % to 10 wt %. For example, based on the total weight of the resin composition RC, the weight of polytetrahydrofuran may be about 2.1 wt %. The adhesive member AP formed from the resin composition RC including 1 wt % to 10 wt % of polytetrahydrofuran based on the total weight of the resin composition RC may exhibit excellent or suitable toughness properties. In an embodiment, when the resin composition RC having a first weight becomes the resin composition RC having a second weight after 1 hour in an open system at a temperature of 30° C., the amount of change in the second weight to the first weight may be less than 0.1%. The first weight may be an initial weight before the elapse of one hour, and the second weight may be a later weight after the elapse of one hour. The amount of change in the second weight to the first weight is represented by a percentage of a value obtained by dividing the difference between the first weight and the second weight by the first weight. For example, when the first weight is 100.0 g (grams) and the second weight is 99.95 g, the amount of change in the second weight to the first weight may be 0.05%.

A resin composition in which the amount of change in the second weight to the first weight is greater than 0.1% has high volatility. When the resin composition having high volatility is paused (or stopped) from being discharged for a set or predetermined amount of time and then resumed for the discharge, recharge and preliminary discharge are required to implement a discharge speed and a discharge amount which may each independently be the same as those before the discharge is paused (or stopped). In some embodiments, when the resin composition having high volatility is paused (or stopped) from being discharged for a set or predetermined amount of time and then resumed for the discharge, a discharge speed and a discharge amount which may each independently be the same as those before the discharge is paused (or stopped) are not implemented.

The resin composition RC not including an acrylate monomer which includes only an unsubstituted alkyl group having 1 to 8 carbon atoms may have an amount of change in the second weight to the first weight of less than 0.1%. Accordingly, the resin composition RC of an embodiment may exhibit excellent or suitable discharge stability.

In an embodiment, when the resin composition RC is applied in a first pattern utilizing a discharge device (e.g., the nozzle NZ), and a second pattern is applied on the first pattern utilizing a discharge device (e.g., the nozzle NZ) after one hour, the first pattern and the second pattern may match. The second pattern may be applied in substantially the same area and the same shape as the first pattern. The second pattern may match the first pattern without defects (e.g., missing patterns). The second pattern may match the first pattern without misalignment from the first pattern. For example, the resin composition RC of an embodiment may stably maintain discharge properties before and after a rest period.

The resin composition RC of an embodiment includes a first urethane acrylate having a weight average molecular weight (weight average molar mass, Mw) of 5,000 to 10,000 and a second urethane acrylate having a weight average molecular weight of greater than 10,000 to 40,000, and the sum of the weight of the first urethane acrylate and the weight of the second urethane acrylate may be 5 wt % to 15 wt %. The resin composition RC of an embodiment may not include (e.g., may exclude) a monofunctional acrylate monomer which includes only an unsubstituted alkyl group having 1 to 8 carbon atoms. Accordingly, the resin composition RC of an embodiment may exhibit low volatility and excellent or suitable discharge stability.

The resin composition RC of an embodiment may include at least one photoinitiator. In the resin composition RC, the photoinitiator may include phenylbis(2,4,6-trimethylbenzoyl)phosphineoxide.

In some embodiments, the resin composition RC may further include one or more photoinitiators, and thus, may include a plurality of photoinitiators. When the resin composition RC includes a plurality of photoinitiators, different photoinitiators may be activated by ultraviolet light with different center wavelengths.

For example, the photoinitiator may include at least one of 2,2-dimethoxy-1,2-diphenylethan-1-one, 1-hydroxy-cyclohexyl-phenyl-ketone, 2-hydroxy-2-methyl-1-phenyl-1-propanone, 2-hydroxy-1-[4-(2-hydroxyethoxy)phenyl]-2-methyl-1-propanone, or 2-hydroxy-1-{4-[4-(2-hydroxy-2-methyl-propionyl)-benzyl]-phenyl}-2-methylpropan-1-one.

In some embodiments, the photoinitiator may include at least one of 2-methyl-1[4-(methylthio)phenyl]-2-morpholinopropan-1-one, 2-benzyl-2-dimethylamino-1-(4-morpholinophenyl)-butanone-1, 2-dimethylamino-2-(4-methyl-benzyl)-1-(4-morpholin-4-yl-phenyl)-butan-1-one, 2,4,6-trimethylbenzoyl-diphenylphosphine oxide, ethyl(2,4,6-trimethylbenzoyl)phenyl phosphinate, [1-(4-phenylsulfanylbenzoyl)heptylideneamino]benzoate, [1-[9-ethyl-6-(2-methylbenzoyl)carbazol-3-yl]ethylideneamino] acetate, or bis(2,4-cyclopentadienyl)bis[2,6-difluoro-3-(1-pyrryl)phenyl] titanium(IV).

The resin composition RC may further include an additive such as a viscosity modifier, a release modifier, a tackifier, a plasticizer, a softener, a silane coupling agent, and/or the like. The additive may be provided within a range that does not change the physical properties of the above-described resin composition. The resin composition RC may further include a silane coupling agent of 3-glycidoxypropyltrimethoxysilane. Referring to FIG. 4A, the resin composition RC may be applied on the substrate CF. The resin composition RC may be provided on the substrate CF through the nozzle NZ. For example, the substrate CF on which the resin composition RC is provided may include polyethylene terephthalate (PET). The substrate CF is a temporary substrate utilized to form the adhesive member AP from the resin composition RC, and may be utilized without limitation as long as it can be easily detached from the adhesive member AP after curing the resin composition RC. One surface of the substrate CF on which the resin composition RC is provided may have been subjected to release treatment.

The resin composition RC may be provided by an inkjet printing method or a dispensing method. The resin composition RC of an embodiment may have a viscosity of 5 mPa·s to 30 mPa·s as measured by the JIS Z8803 method at a temperature of 25° C. In the present specification, the viscosity measured by the JIS Z8803 method at a temperature of 25° C. is shear viscosity.

The resin composition RC having a viscosity of 5 mPa·s to 30 mPa·s as measured by the JIS Z8803 method at a temperature of 25° C. may exhibit excellent or suitable discharge stability. Accordingly, the resin composition RC is easily discharged from a discharge device such as the nozzle NZ, and may be applied in a substantially uniform amount and to a substantially uniform thickness.

On the other hand, in a resin composition having a viscosity of less than 5 mPa·s as measured by the JIS Z8803 method at a temperature of 25° C., a flow of the resin composition occurs. The “flow” refers to a phenomenon in which a resin composition flows out of a member to which the resin composition is to be provided. A resin composition having a viscosity of greater than 30 mPa·s as measured by the JIS Z8803 method at a temperature of 25° C. is not suitable to be provided by an inkjet printing method and a dispensing method. The resin composition having a viscosity of greater than 30 mPa·s as measured by the JIS Z8803 method at a temperature of 25° C. is not easily discharged from a discharge device such as the nozzle NZ, and may not be applied in a substantially uniform amount and/or to a substantially uniform thickness.

In some embodiments, the resin composition RC may have a viscosity of less than 10 mPa·s as measured with a viscometer TVE-25L (a product of TOKI SANGYO) at a temperature of 25° C. The resin composition RC having a viscosity of less than 10 mPa·s as measured with a viscometer TVE-25L (a product of TOKI SANGYO) may be provided by an inkjet printing method or a dispensing method at room temperature.

Referring to FIG. 4B, the first light UV-1 may be provided to the resin composition RC and applied in a substantially uniform thickness on the substrate CF. A liquid resin composition RC may be cured by the first light UV-1 to form a preliminary adhesive member P-AP (see FIG. 4C). The first light UV-1 may be ultraviolet light. FIG. 4B illustrates that the resin composition RC applied on the substrate CF is directly irradiated with the first light UV-1, thereby forming the preliminary adhesive member P-AP, but the embodiment of the present disclosure is not limited thereto. A carrier film may be disposed on the resin composition RC and applied in a substantially uniform thickness, and the carrier film may be configured to transmit ultraviolet light.

Referring to FIGS. 4C and 4D, the preliminary adhesive member P-AP formed by irradiating the resin composition RC with the first light UV-1 may be detached from the substrate CF, and be provided on one surface of the window WP or one surface of the display module DM. One surface of the preliminary adhesive member P-AP may be laminated on one surface of the window WP or one surface of the display module DM, and to the other surface of the preliminary adhesive member P-AP, an unattached one surface of the window WP or an unattached one surface of the display module DM may be attached. The preliminary adhesive member P-AP may be irradiated with the second light UV-2 to form the adhesive member AP (see FIG. 3). The second light UV-2 may be provided from an upper portion of the window WP, and the window WP may be configured to transmit the second light UV-2. The second light UV-2 may be transmitted through the window WP and provided to the preliminary adhesive member P-AP.

The second light UV-2 may be ultraviolet light. The amount of light of the second light UV-2 may be greater than the amount of light of the first light UV-1. The total amount of the light UV-2 provided to the preliminary adhesive member P-AP may be greater than the total amount of the light UV-1 provided to the resin composition RC.

The resin composition RC of an embodiment may have a 180° peel strength of 1000 gf/25 mm or greater for a glass substrate at a temperature of 25° C. after curing by the light UV-1 and UV-2. The resin composition RC of an embodiment may exhibit excellent or suitable adhesion reliability after the curing.

FIG. 5A-FIG. 5C schematically show steps (acts or tasks) of a method for manufacturing the adhesive member AP, which is different from the method for manufacturing the adhesive member AP described with reference to FIGS. 4A-4D. Hereinafter, in describing FIG. 5A-5C, the same contents as those described with reference to FIGS. 1-4D will not be described again, and instead, differences will be mainly described.

A resin composition RC may be directly provided on one surface of a display module DM or on one surface of a window WP. In FIG. 5A, the resin composition RC is illustrated as being directly provided on one surface of the display module DM. The resin composition RC having a viscosity of 5 mPa·s to 30 mPa·s as measured by the JIS Z8803 method at a temperature of 25° C. may be provided while covering the curve of a step SP-b portion in the display module DM.

The resin composition RC has a low viscosity value of 30 mPa·s or less, and thus, may be applied leaving no empty space in a portion having a curve such as the step SP-b. In some embodiments, the resin composition RC having a viscosity value of 5 mPa·s or greater may be applied in a substantially uniform thickness without being provided (e.g., flowed) out of a portion to which the resin composition RC is to be provided, that is, the display module DM.

Referring to FIG. 5B, a first light UV-1 may be provided to the resin composition RC uniformly applied. As the first light UV-1 is provided to the resin composition RC, a preliminary adhesive member P-AP may be formed. A window WP may be provided on the preliminary adhesive member P-AP. In FIG. 5C, a second light UV-2 may be transmitted through the window WP and provided to the preliminary adhesive member P-AP. The preliminary adhesive member P-AP may be cured by the second light UV-2 to form an adhesive member AP (see FIG. 3).

The resin composition RC of an embodiment may include first to third monofunctional acrylate monomers. The first monofunctional acrylate monomer includes a hydroxy group, and may have a weight of 5 wt % to 20 wt % based on the total weight of the resin composition. The second monofunctional acrylate monomer includes a branched alkyl group having 10 to 20 carbon atoms, and may have a weight of 25 wt % to 40 wt % based on the total weight of the resin composition. The third monofunctional acrylate monomer includes a non-aromatic ring group, and may have a weight of 5 wt % to 20 wt % based on the total weight of the resin composition. Accordingly, the resin composition RC of an embodiment may exhibit excellent or suitable discharge stability before curing, and may exhibit high adhesion after the curing.

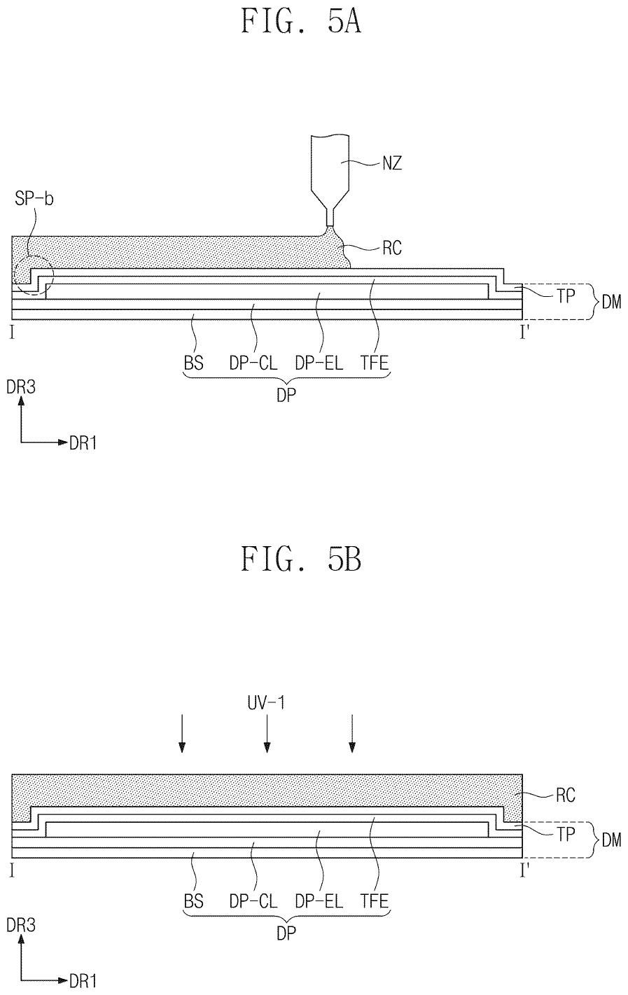

FIG. 6 is a cross-sectional view showing a display device according to an embodiment of the present disclosure. Hereinafter, in the description of the display device illustrated in FIG. 6, the same contents as those described with reference to FIG. 1A to FIG. 5D will not be described again, and instead, differences will be mainly described.

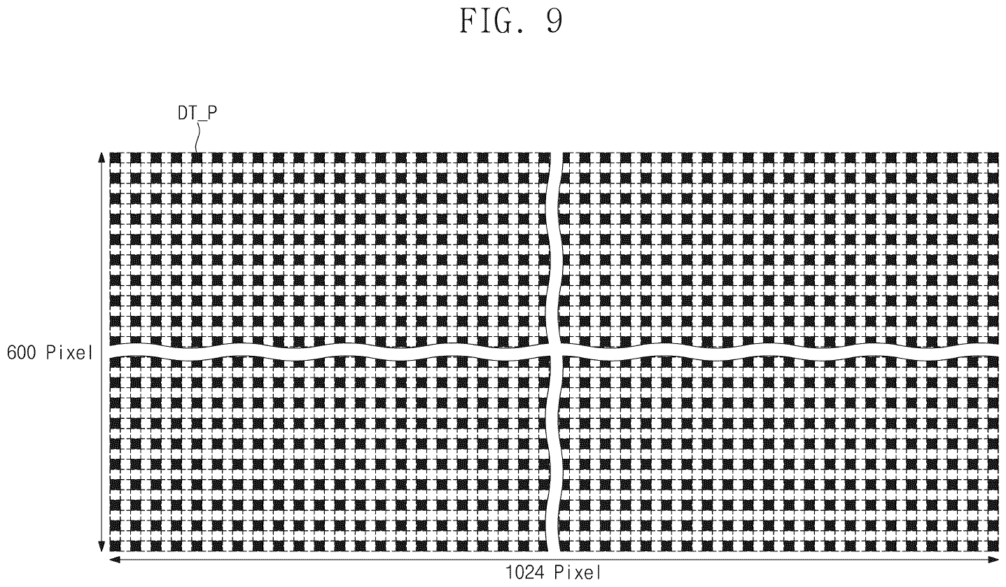

Compared to the display device DD described with reference to FIGS. 2 and 3, a display device DD-a illustrated in FIG. 10 may further include a light control layer PP and an optical adhesive layer AP-a. The display device DD-a of an embodiment may further include the light control layer PP disposed between the adhesive member AP and the window WP, and the optical adhesive layer AP-a disposed between the light control layer PP and the window WP.

The light control layer PP may be disposed on the display panel DP to control reflected light in the display panel DP by external light. The light control layer PP may include, for example, a polarizing plate or a color filter layer.

The optical adhesive layer AP-a may be formed from the resin composition RC according to an embodiment. The optical adhesive layer AP-a including a polymer derived from the resin composition RC may have a 180° peel strength of 1000 gf/25 mm or greater for a glass substrate at a temperature of 25° C. The optical adhesive layer AP-a including the polymer derived from the resin composition RC may exhibit excellent or suitable adhesion reliability. The display device DD-a including the optical adhesive layer AP-a may exhibit excellent or suitable reliability.

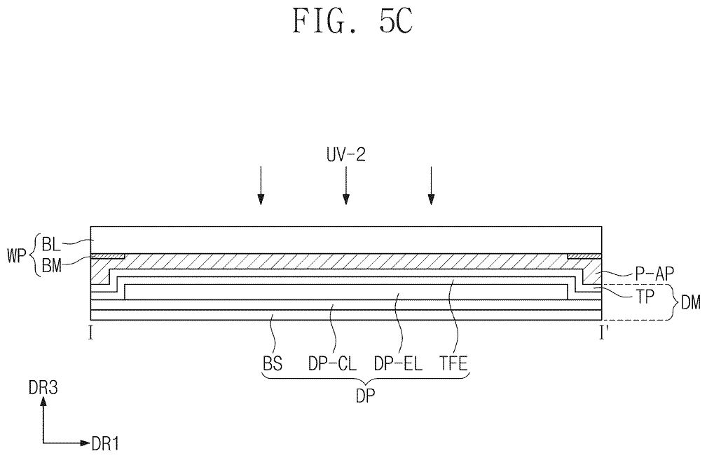

FIG. 7 is a cross-sectional view showing a display device according to an embodiment. Hereinafter, in the description of the display device of an embodiment illustrated in FIG. 7, the same contents as those described above with reference to FIGS. 1 to 6 will not be described again, and instead, differences will be mainly described.

Compared to the display device DD described with reference to FIGS. 2 and 3, a display device DD-b of an embodiment illustrated in FIG. 7 may further include the light control layer PP, the optical adhesive layer AP-a, and an interlayer adhesive layer PIB. The display device DD-b of an embodiment illustrated in FIG. 7 may further include the light control layer PP disposed between the adhesive member AP and the window WP, and the optical adhesive layer AP-a disposed between the light control layer PP and the window WP, as in the case of the display device DD-a of an embodiment illustrated in FIG. 6.

In the display device DD-b of an embodiment, the adhesive member AP may be provided between the display panel DP and the input sensing unit TP. For example, the input sensing unit TP is not directly disposed on the display panel DP, but instead, the display panel DP and the input sensing unit TP may be coupled to each other by the adhesive member AP. For example, the adhesive member AP may be disposed between the encapsulation layer TFE (see FIG. 3) of the display panel DP and the input sensing unit TP.

On a lower side of the light control layer PP, the interlayer adhesive layer PIB may be provided. The interlayer adhesive layer PIB is disposed between the input sensing unit TP and the light control layer PP, and may be formed of an adhesive material having excellent or suitable moisture permeability prevention properties. For example, the interlayer adhesive layer PIB may be formed by including polyisobutylene. The interlayer adhesive layer PIB may be disposed on the input sensing unit TP to prevent or reduce the corrosion of sensing electrodes of the input sensing unit TP. The display device DD-b of an embodiment includes the optical adhesive layer AP-a and the adhesive member AP formed from the resin composition RC of an embodiment, and the display device DD-b including the optical adhesive layer AP-a and the adhesive member AP may exhibit excellent or suitable reliability.

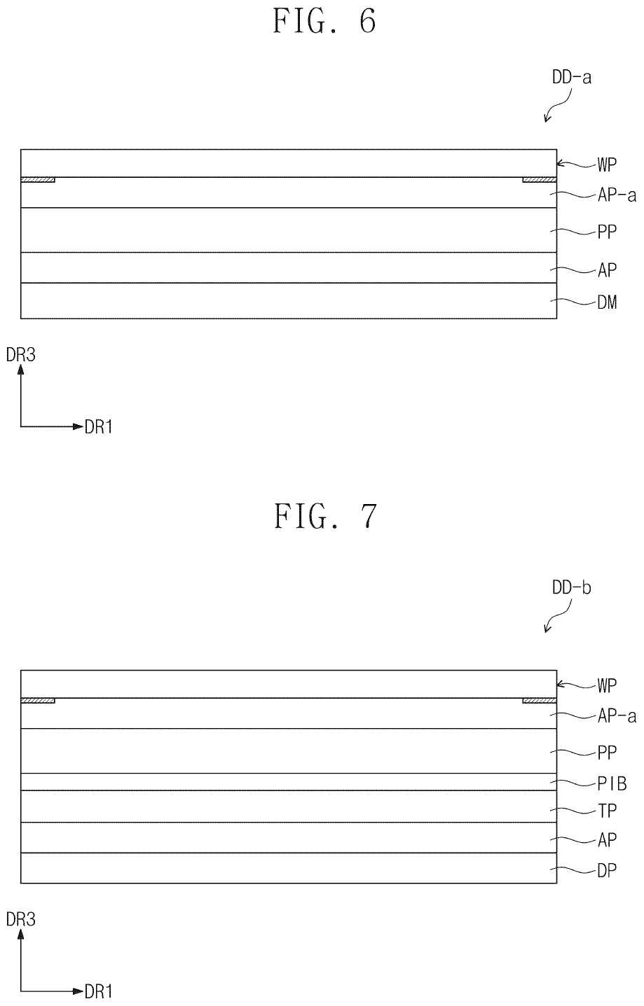

FIG. 8 is a view showing a vehicle AM in which first to fourth display devices DD-1, DD-2, DD-3, and DD-4 are disposed. At least one selected from among the first to fourth display devices DD-1, DD-2, DD-3, and DD-4 may include the same configuration as any one selected from among the display devices DD, DD-a, DD-b of an embodiment described with reference to FIGS. 1 to 3, 6, and 7. At least one selected from among the first to fourth display devices DD-1, DD-2, DD-3, and DD-4 may include the adhesive member AP of an embodiment described with reference to FIGS. 1 to 3, 6, and 7.

FIG. 8 illustrates a car as the vehicle AM, but this is only an example, and the first to fourth display devices DD-1, DD-2, DD-3, and DD-4 may be disposed in other refers to of transportation such as bicycles, motorcycles, trains, ships, and airplanes. In some embodiments, at least one selected from among the first to fourth display devices DD-1, DD-2, DD-3, and DD-4 including the same configuration of any one selected from the display devices DD, DD-a, and DD-b of an embodiment may be employed in other electronic devices without departing from the present disclosure.

At least one selected from among the first to fourth display devices DD-1, DD-2, DD-3, and DD-4 may include the adhesive member AP of an embodiment. The adhesive member AP of an embodiment may be formed from the resin composition RC of an embodiment, and thus may exhibit excellent or suitable adhesion reliability. The adhesive member AP may have a 180° peel strength of 1000 gf/25 mm or greater for a glass substrate at a temperature of 25° C. Accordingly, among the first to fourth display devices DD-1, DD-2, DD-3, and DD-4, a display device including the adhesive member AP of an embodiment may exhibit excellent or suitable reliability.

Referring to FIG. 8, the vehicle AM may include a steering wheel HA and a gear GR for operating the vehicle AM, and a front window GL may be disposed to face a driver.

The first display device DD-1 may be disposed in a first region overlapping the handle HA. For example, the first display device DD-1 may be a digital cluster configured to display first information of the vehicle AM. The first information may include a first scale indicating the driving speed of the vehicle AM, a second scale indicating the number of revolutions of an engine (i.e., revolutions per minute), an image indicating a fuel state, and/or the like. The first scale and the second scale may be displayed as digital images.

The second display device DD-2 may be disposed in a second region facing a driver's seat and overlapping the front window GL. The driver's seat may be a seat in which the steering wheel HA is disposed. For example, the second display device DD-2 may be a head up display (HUD) configured to display second information of the vehicle AM. The second display device DD-2 may be optically transparent. The second information includes a digital number indicating the driving speed of the vehicle AM, and may further include information such as a current time. Unlike what is illustrated, the second information of the second display device DD-2 may be projected and displayed on the front window GL.

The third display device DD-3 may be disposed in a third region adjacent to the gear GR. For example, the third display device DD-3 may be a center information display (CID) for vehicle information guide disposed between the driver's seat and a front passenger's seat and configured to display third information. The front passenger's seat may be a seat separated from the driver's seat with the gear GR interposed therebetween. The third information may include information about road conditions (e.g., navigation information), music or radio playback, dynamic videos (or images) playback, the temperature inside the vehicle AM, and/or the like.

The fourth display device DD-4 may be spaced apart from the steering wheel HA and the gear GR, and disposed in a fourth region adjacent to a side portion of the vehicle AM. For example, the fourth display device DD-4 may be a digital side mirror configured to display fourth information. The fourth display device DD-4 may display an external image of the vehicle AM photographed with a camera module CM disposed on an outer side of the vehicle AM. The fourth information may include an external image of the vehicle AM.

The first to fourth information described above is only example, and the first to fourth display devices DD-1, DD-2, DD-3, and DD-4 may further display information related to the interior and exterior of a vehicle. The first to fourth information may include information different from each other. However, the embodiment of the present disclosure is not limited thereto, and some of the first to fourth information may include the same information.

Hereinafter, referring to Examples and Comparative Examples, a resin composition according to an embodiment of the present disclosure and an adhesive member formed from the resin composition will be described in more detail. In addition, Examples shown are for illustrative purposes only to facilitate the understanding of the present disclosure, and thus, the scope of the present disclosure is not limited thereto.

### Examples

### 1. Resin Composition and Adhesive Member

### (1) Preparation of Resin Composition

Resin compositions of Examples and Comparative Examples were prepared according to blending ratios listed in Tables 1 and 2. Materials listed in Tables 1 and 2 were provided in light-blocking poly container at their respective weight ratios. In addition, as a photoinitiator, Omnirad 819 (IGM Resin Co., Ltd.) was provided in an amount of 2 wt % based on the total weight of the resin composition. Thereafter, a three-one motor (a product of Shinto Scientific Co., Ltd.) was utilized as a stirrer to uniformly mix a composition, and stirring was performed at room temperature at 100 rpm for 1 hour to prepare the resin composition of each of Examples and Comparative Examples.

TABLE 1

| | Molecular | Example | Example | Example | Example |
|---|---|---|---|---|---|
| Material | weight | A1 | A2 | A3 | A4 |
| UV-3700B | 38000 | 3 | 3 | 6 | 9 |
| UV-3300B | 13000 | 2 | 2 | 4 | 6 |
| 4-HBA | 144 | 8 | 3 | 20 | 10 |
| IBXA | 208 | 25 | 30 | 20 | 20 |
| IDAA | 212 | 37 | 40 | 40 | 25 |
| THF-A | 156 | 25 | 22 | 10 | 30 |
| 2-EHA | 184 | | | | |

TABLE 2

| | | Com- | Com- | Com- | Com- | Com- | Com- | Com- |
|---|---|---|---|---|---|---|---|---|
| | | parative | parative | parative | parative | parative | parative | parative |
| | Molecular | Example | Example | Example | Example | Example | Example | Example |
| Material | weight | C1 | C2 | C3 | C4 | C5 | C6 | C7 |
| UV-3700B | 35000 | 3 | 3 | 9 | 1 | | | 10 |
| UV-3300B | 10000 | 2 | 2 | 6 | 1 | | 10 | |
| UF-C052 | 10000 | | | | | 5 | | |
| UC-102M | 17000 | | | | | | 1 | |
| Polyrotaxane | 130000 | | | | | | | 5 |
| 4-HBA | 144 | 15 | 5 | 10 | | 20 | | |
| IBXA | 208 | | | | | | | |
| IDAA | 212 | | | | 98 | 75 | 89 | 85 |
| THF-A | 156 | 20 | 20 | 30 | | | | |
| 2-EHA | 184 | 60 | 70 | 45 | | | | |

### Data on FIG. Tables 1 and 2

UV-3700B: Urethane acrylate (a product of Mitsubishi Chemical Corporation)
UV-3300B: Urethane acrylate (a product of Mitsubishi Chemical Corporation)
UF-C052: Urethane acrylate (a product of Kyoeisha Kagaku Co. Ltd.)
UC-102M: UV-curable isoprene (a product of KURARAY Co. Ltd.)
Polyrotaxane: Synthesized by a method described in Macromolecules 2017,50,5695-5700
4-HBA: 4-hydroxybutyl acrylate (a product of Osaka Organic Chemical Industry Ltd.)
IBXA: Isobornyl acrylate (a product of Osaka Organic Chemical Industry Ltd.)
IDAA: Iso-decyl acrylate (a product of Osaka Organic Chemical Industry Ltd.)
THF-A: Tetrahydrofurfuryl acrylate (a product of KYOEISHA CHEMICAL Co., Ltd.)
2-EHA: 2-ethylhexyl acrylate (a product of TOAGOSEI Co., Ltd.)

In Tables 1 and 2, the molecular weight of UV-3700B, UV-3300B, UF-C052, UC-102M, and polyrotaxane is a weight average molecular weight (Mw). the molecular weight of UV-3700B, UV-3300B, UF-C052, UC-102M, and polyrotaxane is a weight average molecular weight (Mw). In Tables 1 and 2, UV-3700B corresponds to a urethane acrylate having a weight average molecular weight of greater than 10000 to 40000, and UV-3300B corresponds to a urethane acrylate having a weight average molecular weight of 5000 to 10000. 4-HBA corresponds to a first monofunctional acrylate monomer including a hydroxy group, IBXA corresponds to a third monofunctional acrylate monomer including a non-aromatic ring group, and IDAA corresponds to a second monofunctional acrylate monomer including a branched alkyl group having 10 to 20 carbon atoms. 2-EHA corresponds to a monofunctional acrylate monomer including only an unsubstituted alkyl group having 1 to 8 carbon atoms.

The resin composition of each of Examples A1 to A4 is the resin composition according to an embodiment, and includes the first to third monofunctional acrylate monomers, wherein the weight of each of the first to third monofunctional acrylate monomers satisfies the weight range according to an embodiment. In an embodiment, based on the total weight of the resin composition, the weight of the first monofunctional acrylate monomer is 5 wt % to 20 wt %, the weight of the second monofunctional acrylate monomer is 25 wt % to 40 wt %, and the weight of the third monofunctional acrylate monomer is 20 wt % to 30 wt %.

In addition, the resin composition of each of Examples A1 to A4 includes a second urethane acrylate having a weight average molecular weight of greater than 10000 to 40000 and a first urethane acrylate having a weight average molecular weight of 5000 to 10000, and not including a monofunctional acrylate monomer which includes only an unsubstituted alkyl group having 1 to 8 carbon atoms. In the resin composition of each of Examples A1 to A4, the sum of the weight of the first urethane acrylate and the weight of the second urethane acrylate is 5 wt % to 15 wt % based on the total weight of the resin composition.

The resin composition of each of Comparative Examples C1 to C3 does not include the second and third monofunctional acrylate monomers. In addition, the resin composition of each of Comparative Examples C1 to C3 includes the monofunctional acrylate monomer including only the unsubstituted alkyl group having 1 to 8 carbon atoms. The resin composition of Comparative Example C4 does not include the first and third monofunctional acrylate monomers. Also in the resin composition of Comparative C4, the sum of the weight of the first urethane acrylate and the weight of the second urethane acrylate is less than 5 wt % based on the total weight of the resin composition.

The resin composition of Comparative Example C5 does not include the third monofunctional acrylate monomer. The resin composition of each of Comparative Examples C6 and C7 does not contain the first and third monofunctional acrylate monomers. In addition, the resin composition of each of Comparative Examples C5 and C6 does not include the second urethane acrylate having a weight average molecular weight of greater than 10000 to 40000. The resin composition of Comparative Example C7 does not include the first urethane acrylate having a weight average molecular weight of 5000 to 10000.

### (1-2) Evaluation of Resin Composition and Adhesive Member

Tables 3 and 4 show the evaluation of the volatility, re-dischargeability, and viscosity of the resin composition of each of Examples and Comparative Examples, and the 180° peel strength of the adhesive member formed from the resin composition of each of Examples and Comparative Examples. The re-dischargeability is evaluated by applying the resin composition in a first pattern and applying a second pattern in substantially the same shape and area as the first pattern after one hour, thereby evaluating whether the first pattern and the second pattern match. Hereinafter, the evaluation method will be described in more detail.

### Volatility Evaluation of Resin Composition

The prepared resin composition was weighed in an aluminum bowl with a diameter of 83 mm utilizing a heating moisture meter MS-70 (a product of A&D Company, Ltd.) to weigh 7±1 g of a sample. The aluminum bowl is an open system. The sample was heated from room temperature of 23° C. to 30° C. for 1 hour. From the difference between a weight after the end of the heating (second weight) and a weight before the start of the heating (first weight: 7±1 g), the amount of change in weight calculated in %.

### Re-Dischargeability Evaluation of Resin Composition

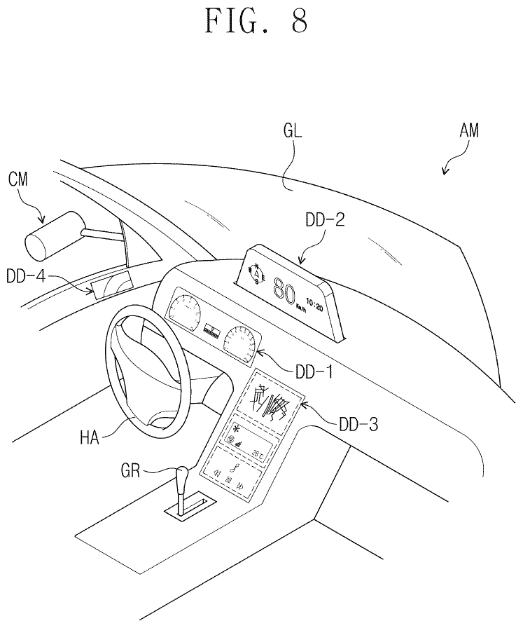

As an inkjet device, a DevicePrinter-CX (a product of MICROJET Corporation) equipped with a KM1024i (a product of Konica Minolta, Inc.) was utilized. The voltage, pulse driving period, and temperature of the device were adjusted such that the discharge speed was 5.5 m/s to 6.5 m/s. Under the obtained discharge conditions, discharge was performed in a set or predetermined pattern (a first pattern composed of dots) and then the discharge was stopped. During the stopping of the discharge, a periodic discharge for preventing or reducing drying was also stopped. After one hour, without performing washing and/or the like, the discharge was performed in substantially the same pattern (a second pattern composed of dots) as the pattern before one hour. As illustrated in FIG. 9, a pattern composed of dots DT_P was applied on the basis of 1024×600 pixels.

The missing and misalignment of the dots of the second pattern with respect to the dots of the first pattern were observed with a digital microscope DX-1000 (a product of Olympus Corporation). In Tables 3 and 4, a case in which missing and misalignment of a dot did not occur was recorded as “O,” and a case in which missing and/or misalignment occurred in one or more dots was recorded as “X.”

FIG. 10A is an image showing a case in which missing and misalignment of a dot has not occurred. FIG. 10B is an image showing a case in which missing and misalignment of a dot has occurred, and DL-1 and DL-2 are portions in which a dot is misaligned in a pattern.

### Evaluation of Viscosity of Resin Composition

The shear viscosity of the prepared resin composition was measured by the JIS Z8803 at a temperature of 25° C. The shear viscosity of the resin composition was measured under a 10 rpm speed condition with a viscometer TVE-25L (a product of TOKI SANGYO Co. Ltd.).

### Measurement of 180° Peel Strength of Adhesive Member

A prepared liquid resin composition was applied to a thickness of 200 μm on a soda-lime glass (a product of Central Glass Co., Ltd.) having a size of 26 mm×76 mm utilizing an inkjet device. As the inkjet device, a DevicePrinter-CX (a product of MICROJET Corporation) equipped with a KM1024i (a product of Konica Minolta, Inc.) was utilized.

Using UV LED lamps respectively having peaks at 365 nm and 395 nm, the soda lime glass on which the liquid resin composition was applied was irradiated with ultraviolet light such that accumulated amounts of light were respectively 800 mJ/cm² and 400 mJ/cm². A PET film (Toyobo Co., Ltd., a A4360 product, thickness 50 μm) cut to a size of 20 mm×150 mm was provided to the soda lime glass irradiated with the ultraviolet light, and was bonded thereto by being applied with a pressure of 0.15 MPa. Thereafter, the resin composition was cured by being irradiated with ultraviolet light utilizing a UV LED lamp having a peak of 395 nm on the PET film side such that an accumulated amount of light was 4000 mJ/cm² to obtain a sample. The peel strength of the obtained sample was measured three times at a temperature of 25° C. utilizing a universal testing machine (Instron Corporation, product type or kind 5965) at a rate of 300 mm/min such that the peel angle was 180°. An average value of about 50 mm peeling was obtained, and the obtained value was multiplied by 1.25 to record a peel strength with respect to a width of 25 mm.

TABLE 3

| | Example | Example | Example | Example |
|---|---|---|---|---|
| | A1 | A2 | A3 | A4 |
| Volatility | 0 | 0 | 0 | 0 |
| Re-discharge | ◯ | ◯ | ◯ | ◯ |
| properties | | | | |
| Viscosity [mPa · s, | 9 | 10 | 22 | 30 |
| 25° C.] | | | | |
| 180° peel strength | 2300 | 1900 | 3500 | 2850 |
| [gf/25 mm, 25° C.] | | | | |

Referring to Table 3, it can be seen that the resin composition of each of Examples A1 to A4 had no change in weight after one hour elapsed at a temperature of 30° C. For example, in the resin composition of each of Examples A1 to A4, it can be seen that the amount of change in the second weight to the first weight was 0%. In addition, in the resin composition of each of Examples A1 to A4, it can be seen that the missing or misalignment of a dot did not occur in the re-dischargeability evaluation. For example, in the resin composition of each of Examples A1 to A4, it can be seen that the first pattern and the second pattern matched.

In the resin composition of each of Examples A1 to A4, it can be seen that the viscosity as measured by the JIS Z8803 method at a temperature of 25° C. was 5 mPa·s to 30 mPa·s. It can be seen that the adhesive member formed from the resin composition of each of Examples A1 to A4 had a 180° peel strength of 1000 gf/25 mm or greater for the glass substrate at a temperature of 25° C. As described with reference to Table 1, the resin composition of each of Examples A1 to A4 is the resin composition according to an embodiment. Therefore, it can be confirmed that the resin composition of an embodiment exhibits low viscosity properties at a temperature of 25° C., and exhibits excellent or suitable discharge stability. In addition, it can be confirmed that the resin composition of an embodiment exhibits excellent or suitable adhesion reliability after curing.

TABLE 4

| | Com- | Com- | Com- | Com- | Com- | Com- | Com- |
|---|---|---|---|---|---|---|---|
| | parative | parative | parative | parative | parative | parative | parative |
| | Example | Examples | Example | Example | Example | Example | Example |
| | C1 | C2 | C3 | C4 | C5 | C6 | C7 |
| Volatility | 0.19 | 0.2 | 0.16 | 0 | 0 | 0 | 0 |
| Re-discharge | X | X | X | ◯ | ◯ | ◯ | ◯ |
| properties | | | | | | | |
| Viscosity | — | — | — | 8 | 10 | 9 | 16 |
| [mPa · s, 25° C.] | | | | | | | |
| 180° peel | — | — | — | 50 | 800 | 600 | 40 |
| strength | | | | | | | |
| [gf/25 mm, 25° C.] | | | | | | | |

Referring to Table 4, it can be seen that the resin composition of each of Comparative Example C1 to C3 had an amount of change in weight of 0.1% or greater after one hour elapsed at a temperature of 30° C. For example, in the resin composition of each of Comparative Example C1 to C3, it can be seen that the amount of change in the second weight to the first weight was 0.1% or greater. Also, in the resin composition of each of Examples C1 to C3, it can be seen that the missing or misalignment of a dot occurred in the re-dischargeability evaluation. For example, in the resin composition of each of Comparative Example C1 to C3, it can be seen that the first pattern and the second pattern did not match. The resin composition of each of Comparative Examples C1 to C3 was recorded as “X” in the re-dischargeability evaluation, and the viscosity and peel strength were not evaluated.

As described with reference to Table 2, the resin composition of each of Comparative Examples C1 to C3 do not include the second and third monofunctional acrylate monomers, and include the monofunctional acrylate monomer including the unsubstituted alkyl group having 1 to 8 carbon atoms (i.e., 2-ethylhexyl acrylate). Accordingly, the resin composition of each of Comparative Examples C1 to C3 has high volatility, and degraded discharge stability.

It can be seen that the adhesive member formed from the resin composition of each of Comparative Examples C4 to C7 had a 180° peel strength of less than 1000 gf/25 mm for the glass substrate at a temperature of 25° C. It can be seen that the resin composition of each of Comparative Examples C4 to C7 has low adhesion after the curing. As described with reference to Table 2, the resin composition of Comparative Example C4 does not include the first and third monofunctional acrylate monomers, and the sum of the weight of the first urethane acrylate and the weight of the second urethane acrylate is less than 5 wt % based on the total weight of the resin composition. The resin composition of each of Comparative Examples C5 to C7 does not include at least one among the first and third monofunctional acrylate monomers, and does not include any one of the first and second urethane acrylates. Accordingly, the resin composition of each of Comparative Examples C4 to C7 exhibited low adhesion after the curing.

### 2. Resin Composition and Adhesive Member

### (2-1) Preparation of Resin Composition

Resin compositions of Examples and Comparative Examples were prepared according to blending ratios listed in Tables 5 and 6. Materials listed in Tables 5 and 6 were provided in light-blocking poly container at their respective weight ratios. In addition, as a photoinitiator, Omnirad 819 (IGM Resin Co., Ltd.) was provided in an amount of 2 wt % based on the total weight of the resin composition. Thereafter, a three-one motor (a product of Shinto Scientific Co., Ltd.) was utilized as a stirrer to uniformly mix a composition, and stirring was performed at room temperature at 100 rpm for 1 hour to prepare the resin composition of each of Examples and Comparative Examples.

TABLE 5

| | Molecular | Example | Example | Example | Example |
|---|---|---|---|---|---|
| Material | weight | B1 | B2 | B3 | B4 |
| UF-C051 | 35000 | 3 | 3 | 6 | 9 |
| UF-C052 | 10000 | 2 | 2 | 4 | 6 |
| 4-HBA | 144 | 15 | 5 | 10 | 10 |
| IBXA | 208 | 25 | 30 | 20 | 20 |
| IDAA | 212 | 35 | 40 | 40 | 25 |
| THF-A | 156 | 20 | 20 | 20 | 30 |
| 2-EHA | 184 | | | | |

TABLE 6

| | | Com- | Com- | Com- | | Com- |
|---|---|---|---|---|---|---|
| | | parative | parative | parative | | parative |
| | Molecular | Example | Example | Example | | Example |
| Materials | weight | D1 | D2 | D3 | | D4 |
| UF-C051 | 35000 | 3 | 3 | 9 | | 1 |
| UF-C052 | 10000 | 2 | 2 | 6 | | 1 |
| 4-HBA | 144 | 15 | 5 | 10 | | |
| IBXA | 208 | 25 | 30 | 20 | | |
| IDAA | 212 | | | | | 98 |
| THF-A | 156 | 20 | 20 | 30 | | |
| 2-EHA | 184 | 35 | 40 | 25 | | |
| | | Com- | Com- | Com- | Com- | Com- |
| | | parative | parative | parative | parative | parative |
| | Molecular | Example | Example | Example | Example | Example |
| Material | weight | D5 | D6 | D7 | D8 | D9 |
| UF-C051 | 35000 | 7 | 5 | 10 | 10 | 10 |
| UF-C052 | 10000 | 7 | | | | |
| 4-HBA | 144 | 16 | 25 | | 90 | |
| IBXA | 208 | | | | | 5 |
| IDAA | 212 | | 70 | 90 | | 85 |
| THF-A | 156 | | | | | |
| 2-EHA | 184 | 70 | | | | |

### Data on Tables 5 and 6

UF-C051: Urethane acrylate (a product of Kyoeisha Chemical Co., Ltd.)
UF-C052: Urethane acrylate (a product of Kyoeisha Chemical Co., Ltd.)

In Tables 5 and 6, the same contents described above in the data on Tables 1 and 2 are applied to 4-HBA, IBXA, IDAA, THF-A, and 2-EHA.

In Tables 5 and 6, the molecular weight of UF-C051 and UF-C052 is a weight average molecular weight. In Tables 5 and 6, UF-C051 corresponds to a urethane acrylate having a weight average molecular weight of greater than 10000 to 40000, and UF-C052 corresponds to a urethane acrylate having a weight average molecular weight of 5000 to 10000.

The resin composition of each of Examples B1 to B4 is the resin composition according to an embodiment, and includes the first to third monofunctional acrylate monomers, wherein the weight of each of the first to third monofunctional acrylate monomers satisfies the weight range according to an embodiment. In an embodiment, based on the total weight of the resin composition, the weight of the first monofunctional acrylate monomer is 5 wt % to 20 wt %, the weight of the second monofunctional acrylate monomer is 25 wt % to 40 wt %, and the weight of the third monofunctional acrylate monomer is 20 wt % to 30 wt %.

In addition, the resin composition of each of Examples B1 to B4 includes a second urethane acrylate having a weight average molecular weight of greater than 10000 to 40000 and a first urethane acrylate having a weight average molecular weight of 5000 to 10000, and not including a monofunctional acrylate monomer which includes only an unsubstituted alkyl group having 1 to 8 carbon atoms. In the resin composition of each of Examples B1 to B4, the sum of the weight of the first urethane acrylate and the weight of the second urethane acrylate is 5 wt % to 15 wt % based on the total weight of the resin composition.

The resin composition of each of Comparative Examples D1 to D3 includes the monofunctional acrylate monomer including only an unsubstituted alkyl group having 1 to 8 carbon atoms. Also, the resin composition of each of Comparative Examples D1 to D3 does not include the second monofunctional acrylate monomer including a branched alkyl group having 10 to 20 carbon atoms.

In the resin composition of Comparative D4, the sum of the weight of the first urethane acrylate and the weight of the second urethane acrylate is less than 5 wt % based on the total weight of the resin composition. The resin composition of Comparative Example D4 does not include the first monofunctional acrylate monomer including a hydroxy group and the third monofunctional acrylate monomer including a non-aromatic ring group.

The resin composition of Comparative Example D5 includes the monofunctional acrylate monomer including only the unsubstituted alkyl group having 1 to 8 carbon atoms. The resin composition of Comparative Example D5 does not include the third monofunctional acrylate monomer including the non-aromatic ring group and the second monofunctional acrylate monomer including the branched alkyl group having 10 to 20 carbon atoms.

The resin composition of each of Comparative Examples D6 to D9 does not include the first urethane acrylate having a weight average molecular weight of 5000 to 10000. Also, the resin composition of Comparative Example D6 does not include the third monofunctional acrylate monomer including the non-aromatic ring. The resin composition of Comparative Example D7 does not include the first monofunctional acrylate monomer including the hydroxy group and the third monofunctional acrylate monomer including a non-aromatic ring group.

The resin composition of Comparative Example D8 does not include the third monofunctional acrylate monomer including the non-aromatic ring group and the second monofunctional acrylate monomer including a second branched alkyl group having 10 to 20 carbon atoms. The resin composition of Comparative Example D9 does not include the first monofunctional acrylate monomer including the hydroxy group.

### (2-2) Evaluation of Resin Composition and Adhesive Member

Tables 7 and 8 show the evaluation of the re-dischargeability and viscosity of the resin composition of each of Examples and Comparative Examples, and the 180° peel strength of the adhesive member formed from the resin composition of each of Examples and Comparative Examples. The re-dischargeability is evaluated by applying the resin composition in a first pattern and applying a second pattern in substantially the same shape and area as the first pattern after one hour, thereby evaluating whether the first pattern and the second pattern match. The evaluation of the re-dischargeability of the resin composition, the measurement of the viscosity of the resin composition, and the measurement of the 180° peel strength of the adhesive member were performed in substantially the same manner as the evaluation methods of Tables 3 and 4.

TABLE 7

| | Example | Example | Example | Example |
|---|---|---|---|---|
| | B1 | B2 | B3 | B4 |
| Re-dischargeability | ◯ | ◯ | ◯ | ◯ |
| Viscosity [mPa · s, | 9 | 12 | 15 | 23 |
| 25° C.] | | | | |
| 180° peel strength | 2800 | 2300 | 3200 | 3000 |
| [gf/25 mm, 25° C.] | | | | |

Referring to Table 7. in the resin composition of each of Examples B1 to B4, it can be seen that the missing or misalignment of a dot did not occur in the re-dischargeability evaluation. For example, in the resin composition of each of Examples B1 to B4, it can be seen that the first pattern and the second pattern matched.

In the resin composition of each of Examples B1 to B4, it can be seen that the viscosity as measured by the JIS Z8803 method at a temperature of 25° C. was 5 mPa·s to 30 mPa·s. It can be seen that the adhesive member formed from the resin composition of each of Examples B1 to B4 had a 180° peel strength of 1000 gf/25 mm or greater for the glass substrate at a temperature of 25° C. As described with reference to Table 5, the resin composition of each of Examples B1 to B4 is the resin composition according to an embodiment. Accordingly, it can be confirmed that the resin composition of an embodiment exhibits low viscosity properties at a temperature of 25° C., and exhibits excellent or suitable discharge stability before curing. Also, it can be confirmed that the resin composition of an embodiment exhibits excellent or suitable adhesion reliability after the curing.

TABLE 8

| | Comparative | Comparative | Comparative | Comparative |
|---|---|---|---|---|
| | Example | Example | Example | Example |
| | D1 | D2 | D3 | D4 |
| Re-dischargeability | X | X | X | ◯ |
| Viscosity [mPa · s, | — | — | — | 8 |
| 25° C.] | | | | |
| 180° peel strength | — | — | — | 50 |
| [gf/25 mm, 25° C.] | | | | |

| | Comparative | Comparative | Comparative | Comparative | Comparative |
|---|---|---|---|---|---|
| | Examples | Example | Example | Example | Example |
| | D5 | D6 | D7 | D8 | D9 |
| Re-dischargeability | X | ◯ | ◯ | — | ◯ |
| Viscosity [mPa · s, | 23 | 11 | 15 | 40 | 20 |
| 25° C.] | | | | | |
| 180° peel strength | 800 | 300 | 800 | — | 300 |
| [gf/25 mm, 25° C.] | | | | | |

Referring to Table 8. in the resin composition of each of Comparative Examples D1 to D3, and D5, it can be seen that the missing or misalignment of a dot occurred in the re-dischargeability evaluation. For example, in the resin composition of each of Comparative Examples D1 to D3, and D5, it can be seen that the first pattern and the second pattern did not match. The resin composition of each of Comparative Examples D1 to D3 was recorded as “X” in the re-dischargeability evaluation, and the viscosity and peel strength were not evaluated.

As described with reference to Table 6, the resin composition of each of Comparative Examples D1 to D3, and D5 does include the monofunctional acrylate monomer including the unsubstituted alkyl group having 1 to 8 carbon atoms (i.e.—ethylhexyl acrylate). The resin composition of each of Comparative Examples D1 to D3, and D5 does not include the second monofunctional acrylate monomer including the branched alkyl group having 10 to 20 carbon atoms. Accordingly, the resin composition of each of Comparative Examples D1 to D3, and D5 has degraded discharge stability.

It can be seen that the adhesive member formed from the resin composition of each of Comparative Examples D4 to D7, and D9 had a 180° peel strength of less than 1000 gf/25 mm for the glass substrate at a temperature of 25° C. It can be seen that the resin composition of each of Comparative Examples D4 to D7, and D9 has low adhesion after the curing. As described with reference to Table 6, the resin composition of each of Comparative Examples D4 to D7, and D9 does include at least one among the first to third monofunctional acrylate monomers. Also, in the resin composition of Comparative D4, the sum of the weight of the first urethane acrylate and the weight of the second urethane acrylate is less than 5 wt %. The resin composition of each of Comparative Examples D6, D7, and D9 does not include the first urethane acrylate. Accordingly, the resin composition of each of Comparative Examples D4 to D7, and D9 exhibited low adhesion after the curing.

In the resin composition of Comparative Example D8, it can be seen that the viscosity as measured by the JIS Z8803 method at a temperature of 25° C. was greater than 30 mPa·s. As described with reference to Table 6, the resin composition of Comparative Example D8 does not include the third monofunctional acrylate monomer including the non-aromatic ring group and the second monofunctional acrylate monomer including the branched alkyl group having 10 to 20 carbon atoms. Also, the resin composition of Comparative Example D8 does not include the first urethane acrylate. In the resin composition of Comparative Example D8, the viscosity as measured by the JIS Z8803 method at a temperature of 25° C. was greater than 30 mPa·s, and the viscosity and peel strength were not evaluated. Accordingly, the resin composition of Comparative Examples D8 exhibited relatively high viscosity.

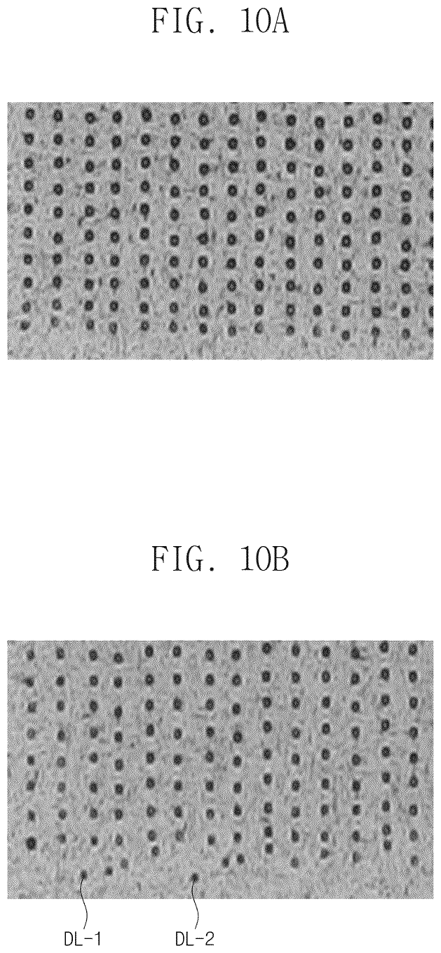

FIG. 11 shows the measurement of the storage modulus according to temperatures in adhesive members formed from the resin compositions of Examples and Comparative Examples. The storage modulus was measured utilizing a rheometer of TA Instruments.

Table 9 shows materials and weight ratios of the materials included in the resin compositions of Examples and Comparative Examples of FIG. 11. The resin composition of each of Examples includes isodecyl acrylate and 1,9-nonanediol diacrylate, and is the resin composition according to an embodiment. The resin composition of each of Comparative Examples does not include isodecyl acrylate and 1,9-nonanediol diacrylate. In the resin compositions of Examples and Comparative Examples, polypropylene glycol having a number average molecular weight (Mn) of 35,000 and a glass transition temperature of −43° C. was utilized. In the resin compositions of Examples and Comparative Examples, polytetrahydrofuran having a number average molecular weight of 13,000 and a glass transition temperature of −74° C. was utilized.

TABLE 9

| | | Comparative | |
|---|---|---|---|
| | | Example | Examples |
| Material | | (wt %) | (wt %) |
| Oligomer | Polypropylene Glycol (PPG) | 5.0 | 2.1 |
| (Oligomer) | Polytetrahydrofuran (PTHF) | 5.0 | 2.1 |
| Monomer | 2-ethylhexyl acrylate (2-EHA) | 38.0 | — |
| (Monomer) | Isodecyl acrylate (IDAA) | — | 36.3 |
| | 4-ethylhexyl acrylate (4-HBA) | 10.0 | 10.4 |
| | Tetrahydrofurfuryl acrylate (THF-A) | 20.0 | 20.8 |
| | Isobornyl acrylate (IBXA) | 19.9 | 25.7 |
| | 1,9-nonanediol diacrylate (Vis#260) | — | 0.5 |
| Additive | 3-Glycidoxypropyltrimethoxysilane (KBM-403) | 0.1 | 0.1 |
| (Addictive) | | | |
| Photo- | Phenylbis(2,4,6- | 2.0 | 2.0 |
| initiator | trimethylbenzoyl)phosphineoxide (Irg 819) | | |
| (Photo- | | | |
| initiator) | | | |

In Table 9, the resin composition of each of Comparative Examples includes 38 wt % of 2-ethylhexyl acrylate (2-EHA) based on the total weight of the resin composition. The resin composition of each of Examples includes 36.3 wt % of isodecyl acrylate (IDAA) and 0.5 wt % of 1,9-nonanediol diacrylate based on the total weight of the resin composition. The resin composition of each of Examples does not include 2-ethylhexyl acrylate.

Referring to FIG. 11, it can be seen that the adhesive member formed from the resin composition of each of Comparative Examples and Examples has a storage modulus of 0.02 MPa or greater at a temperature of 60° C. to 80° C. Compared with the adhesive member formed from the resin composition of each of Comparative Examples, it can be seen that the adhesive member formed from the resin composition of each of Examples exhibits a relatively high storage modulus at a temperature of 60 ºC to 80° C. Accordingly, in an embodiment, the adhesive member formed from the resin composition including 1,9-nonandiol diacrylate may exhibit a relatively high storage modulus at a temperature of 60° C. to 80° C. In an embodiment, the adhesive member formed from the resin composition including 1,9-nonandiol diacrylate may exhibit excellent or suitable reliability at high temperatures.

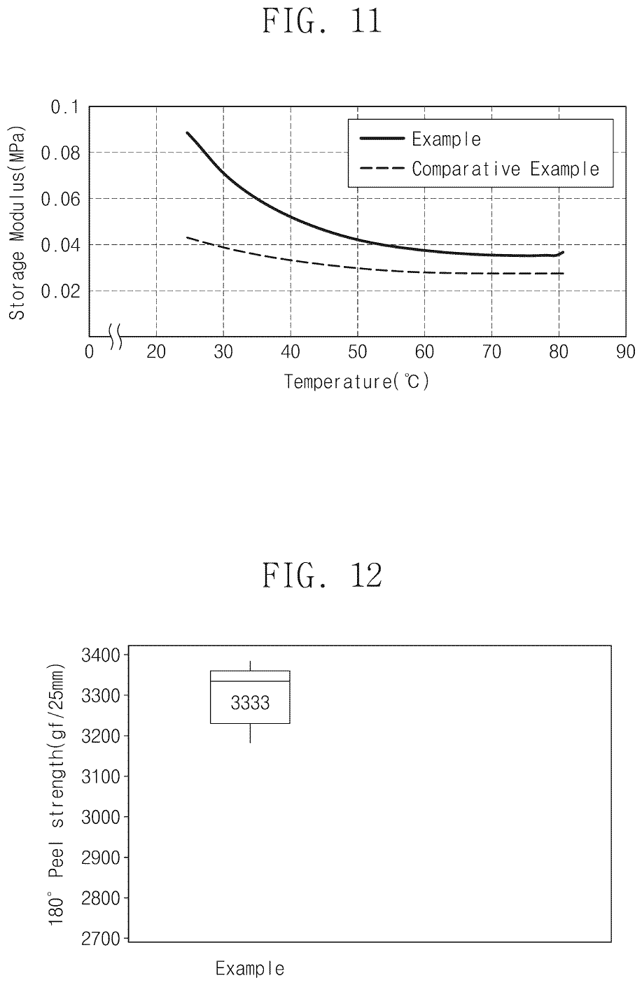

FIG. 12 shows the evaluation of the 180° peel strength for a polymer substrate in the adhesive member formed from the resin composition of each of Examples of Table 9. More specifically, the evaluation of the 180° peel strength for a polarizing plate in the adhesive member is shown. The 180° peel strength was evaluated by sequentially laminating a polarizing plate and an adhesive member on a glass substrate and providing a polyethylene terephthalate (PET) film as a backing film on the adhesive member. The adhesive member was provided in a thickness of 200 μm.

Referring to FIG. 12, it can be seen that the adhesive member formed from the resin composition of each of Example has a 180° peel strength of 3000 gf/25 mm or greater for the polymer substrate. Also, it has been confirmed that the adhesive member formed from the resin composition of each of Examples had an average value of the 180° peel strength of about 3333 gf/25 mm for the polymer substrate. Accordingly, it can be confirmed that the adhesive member formed from the resin composition of an embodiment shows excellent or suitable adhesion reliability.

Table 10 shows the evaluation of the viscosity and first volatility in the resin composition of each of Comparative Examples and Examples of Table 9. The viscosity was measured with a viscometer TVE-25L (a product of TOKI SANGYO) at temperatures of 25° C. and 45° C. The first volatility is a ratio of the change in weight measured by a thermogravimetric analysis (TGA) method. The first volatility is obtained by providing heat to the adhesive member for 30 minutes under a 30° C. temperature condition, and then calculating the change in weight of the adhesive member before and after the heat has been provided, and corresponds to the first volatility described above.

TABLE 10

| | Comparative | |
|---|---|---|
| | Examples | Examples |
| Viscosity at a temperature of | 13.4 | 8.5 |
| 25° C. [mPa · s] | | |
| Viscosity at a temperature of | 8.1 | 5.2 |
| 45° C. [mPa · s] | | |
| First volatility [30 min, 30° C.] | 1.24 | 0.38 |

Referring to Table 10, it can be seen that the resin composition of each of Examples has a viscosity of less than 10 mPa·s at a temperature of 25° C. It can be seen that the resin composition of each of Examples has a first volatility of 1% or less. The resin composition of each of Examples includes isodecyl acrylate, and does not include 2-ethylhexyl acrylate. Accordingly, in an embodiment, the resin composition including the isodecyl acrylate may have a viscosity of less than 10 mPa·s at a temperature of 25° C., and a first volatility of 1% or less. The resin composition having a viscosity of less than 10 mPa·s at a temperature of 25° C., and having a first volatility of 1% or less may be provided by an inkjet printing method or a dispensing method at a temperature of 25° C.

Referring to Table 10, it can be seen that the resin composition of each of Comparative Examples has a first volatility of greater than 1% and a viscosity of greater than 10 mPa·s at a temperature of 25° C. It can be seen that the resin composition of each of Comparative Examples has a viscosity of less than 10 mPa·s at a temperature of 45° C. Therefore, it can be seen that the resin composition of each of Comparative Examples is not suitable to be provided by an inkjet printing method or a dispensing method at a temperature of 25° C. The resin composition of each of Comparative Examples may be provided by an inkjet printing method or a dispensing method at a temperature of 45° C. The resin composition of each of Comparative Examples is provided at relatively high temperatures, and thus causes an increase in manufacturing costs, and reduces manufacturing efficiency.

A display device of an embodiment may include the adhesive member of an embodiment disposed between a display panel and a window. In embodiment, the adhesive member may include a polymer derived from a resin composition. The resin composition of an embodiment may include at least one oligomer, first to third of monofunctional acrylate monomers, and at least one photoinitiator. The first monofunctional acrylate monomer includes a hydroxy group, and may have a weight of 5 wt % to 20 wt % based on the total weight of the resin composition. The second monofunctional acrylate monomer includes a branched alkyl group having 10 to 20 carbon atoms, and may have a weight of 25 wt % to 40 wt % based on the total weight of the resin composition. The third monofunctional acrylate monomer includes a non-aromatic ring group, and may have a weight of 20 wt % to 30 wt % based on the total weight of the resin composition. Accordingly, the resin composition of an embodiment may be provided by an inkjet printing method or a dispensing method, and may exhibit excellent or suitable discharge stability and low volatility before curing. The resin composition of an embodiment may exhibit excellent or suitable adhesion reliability after the curing.

A resin composition of an embodiment includes first to third monofunctional acrylate monomers with optimized weight ranges, and thus may exhibit low volatility and excellent or suitable discharge stability before curing, and may exhibit excellent or suitable adhesion reliability after the curing.

An adhesive member of an embodiment and a display device of an embodiment including the adhesive member include a polymer derived from the resin composition of an embodiment, and thus may exhibit excellent or suitable adhesion reliability.

Although the present disclosure has been described with reference to preferred embodiments of the present disclosure, it will be understood by those skilled in the art that one or more suitable modifications and changes in form and details may be made therein without departing from the spirit and scope of the present disclosure as set forth in the following claims and equivalents thereof.

Accordingly, the technical scope of the present disclosure is not intended to be limited to the contents set forth in the detailed description of the specification, but is intended to be defined by the appended claims.

What is claimed is:

1. A resin composition comprising:
at least one oligomer;
a plurality of monofunctional acrylate monomers; and
at least one photoinitiator,
wherein the plurality of monofunctional acrylate monomers comprise:
a first monofunctional acrylate monomer having a weight of 5 wt % to 20 wt % based on the total weight of the resin composition, and comprising a hydroxy group;
a second monofunctional acrylate monomer having a weight of 25 wt % to 40 wt % based on the total weight of the resin composition, and comprising a branched alkyl group having 10 to 20 carbon atoms; and
a third monofunctional acrylate monomer having a weight of 20 wt % to 30 wt % based on the total weight of the resin composition, and comprising a non-aromatic ring group.

2. The resin composition of claim 1, wherein when the resin composition is applied in a first pattern utilizing a discharge device, and a second pattern having the same area and the same shape as the first pattern is applied on the first pattern after one hour, the first pattern and the second pattern match.

3. The resin composition of claim 1, wherein when the resin composition of a first weight becomes the resin composition of a second weight after 1 hour in an open system at a temperature of 30° C., the amount of change of the second weight to the first weight is less than 0.1%.

4. The resin composition of claim 1, wherein the plurality of monofunctional acrylate monomers do not comprise any monofunctional acrylate monomer comprising only an unsubstituted alkyl group having 1 to 8 carbon atoms.

5. The resin composition of claim 1, wherein based on the total weight of the resin composition, the weight of the third monofunctional acrylate monomer is greater than each of the weight of the first monofunctional acrylate monomer and the weight of the second monofunctional acrylate monomer.

6. The resin composition of claim 1, wherein the oligomer comprises a first urethane acrylate having a weight average molecular weight of 5,000 to 10,000 and a second urethane acrylate having a weight average molecular weight of greater than 10,000 to 40,000.

7. The resin composition of claim 6, wherein based on the total weight of the resin composition, the sum of the weight of the first urethane acrylate and the second urethane acrylate is 5 wt % to 15 wt %.

8. The resin composition of claim 6, wherein based on the total weight of the resin composition, the weight of the second urethane acrylate is greater than the weight of the first urethane acrylate.

9. The resin composition of claim 1, wherein a viscosity measured by the JIS Z8803 method at a temperature of 25° C. is 5 mPa·s to 30 mPa·s.

10. The resin composition of claim 1, wherein after photo-curing, a 180° peel strength for a glass substrate at a temperature of 25° C. is at least 1000 gf/25 mm.

11. The resin composition of claim 1, wherein the resin composition is provided by an inkjet printing method or a dispensing method.

12. An adhesive member comprising:
a polymer derived from a resin composition comprising at least one oligomer;
a plurality of monofunctional acrylate monomers; and
at least one photoinitiator,
wherein the plurality of monofunctional acrylate monomers comprise:
a first monofunctional acrylate monomer having a weight of 5 wt % to 20 wt % based on the total weight of the resin composition, and comprising a hydroxy group;
a second monofunctional acrylate monomer having a weight of 25 wt % to 40 wt % based on the total weight of the resin composition, and comprising a branched alkyl group having 10 to 20 carbon atoms; and
a third monofunctional acrylate monomer having a weight of 20 wt % to 30 wt % based on the total weight of the resin composition, and comprising a non-aromatic ring group.

13. The adhesive member of claim 12, wherein a 180° peel strength for a glass substrate at a temperature of 25° C. is 1000 gf/25 mm or greater.

14. The adhesive member of claim 12, wherein when the resin composition is applied in a first pattern utilizing a discharge device, and a second pattern having the same area and the same shape as the first pattern is applied on the first pattern after one hour, the first pattern and the second pattern match.

15. The adhesive member of claim 12, wherein when the resin composition having a first weight becomes the resin composition having a second weight after 1 hour in an open system at a temperature of 30° C., the amount of change of the second weight to the first weight is less than 0.1%.

16. The adhesive member of claim 12, wherein the plurality of monofunctional acrylate monomers do not comprise any monofunctional acrylate monomer comprising only an unsubstituted alkyl group having 1 to 8 carbon atoms.

17. The adhesive member of claim 12, wherein based on the total weight of the resin composition, the weight of the third monofunctional acrylate monomer is greater than each of the weight of the first monofunctional acrylate monomer and the weight of the second monofunctional acrylate monomer.

18. The adhesive member of claim 12, wherein the oligomer comprises a first urethane acrylate having a weight average molecular weight of 5,000 to 10,000 and a second urethane acrylate having a weight average molecular weight of greater than 10,000 to 40,000.

19. The adhesive member of claim 12, wherein the resin composition has a viscosity of 5 mPa·s to 30 mPa·s when measured by the JIS Z8803 method at a temperature of 25° C.

20. A display device comprising:
a display panel;
a window on the display panel; and
an adhesive member comprising:
a polymer derived from a resin composition which comprises at least one oligomer;
a plurality of monofunctional acrylate monomers; and
at least one photoinitiator, and between the display panel and the window,
wherein the plurality of monofunctional acrylate monomers comprise:
a first monofunctional acrylate monomer having a weight of 5 wt % to 20 wt % based on the total weight of the resin composition, and comprising a hydroxy group;
a second monofunctional acrylate monomer having a weight of 25 wt % to 40 wt % based on the total weight of the resin composition, and comprising a branched alkyl group having 10 to 20 carbon atoms; and
a third monofunctional acrylate monomer having a weight of 20 wt % to 30 wt % based on the total weight of the resin composition, and comprising a non-aromatic ring group.

21. The display device of claim 20, wherein the adhesive member has a 180° peel strength of 1000 gf/25 mm or greater for a glass substrate at a temperature of 25° C.

22. The display device of claim 20, further comprising an input sensing unit between the display panel and the window,
wherein the adhesive member is between the display panel and the input sensing unit or between the input sensing unit and the window.

23. The display device of claim 20, further comprising a light control layer between the adhesive member and the window, and an optical adhesive layer between the light control layer and the window,
wherein the optical adhesive layer comprises a polymer derived from the resin composition.

24. The resin composition of claim 1, wherein the oligomer comprises at least one of polypropylene glycol (PPG) or polytetrahydrofuran (PTHF).

25. The resin composition of claim 24, wherein based on the total weight of the resin composition, the weight of the polypropylene glycol is 1 wt % to 10 wt %.

26. The resin composition of claim 24, wherein based on the total weight of the resin composition, the weight of the polytetrahydrofuran is 1 wt % to 10 wt %.

27. The resin composition of claim 1, further comprising 3-glycidoxypropyltrimethoxysilane.
